(19) United States
(12) Patent Application Publication
(10) Pub. No.: US 2024/0061975 A1
(43) Pub. Date: Feb. 22, 2024

(54) COMPOSABLE DIGITAL TWINS

(71) Applicant: PassiveLogic, Inc., Holladay, UT (US)

(72) Inventor: Troy Aaron Harvey, Brighton, UT (US)

(21) Appl. No.: 18/499,073

(22) Filed: Oct. 31, 2023

Related U.S. Application Data
(63) Continuation-in-part of application No. 17/722,115, filed on Apr. 15, 2022.

(51) Int. Cl. G06F 30/20; G06F 30/12

(52) U.S. Cl. CPC G06F 30/20; G06F 30/12

(57) ABSTRACT

Various embodiments relate to a method, apparatus, and machine-readable storage medium for using a digital twin including one or more of the following: accessing a digital twin stored in memory, wherein the digital twin includes: a plurality of nodes, each node having at least one normalized interface associated with data having a respective data type, and a plurality of edges connecting respective normalized interfaces associated with like data types among the plurality of nodes; propagating data having a first data type through the plurality of nodes along edges of the plurality of edges connected to normalized interfaces associated with the first data type; and extracting data from at least one node of the plurality of nodes to be used as simulation output.

### TECHNICAL FIELD

Various embodiments described herein relate to digital models and, more specifically but not exclusively, to composable digital twins for real world systems.

### BACKGROUND

While digital twins have been promoted as a key emerging technology, current applications do not yet fully realize the untapped value in this approach to modeling. Existing solutions tend to fall into two categories. First, basic descriptions of systems are sometimes called digital twins. This category refers simply to an inert data object that describes how to render a system for visualization, such as in a computer aided drafting application. Second, special-purpose simulators are referred to as digital twins. These leverage mathematics tuned to one specific component for simulation, but do not have much use beyond that one purpose. If a new component is to be simulated, the user is left to start over from scratch to model the new unique mathematics. Accordingly, there is a need for improvements to digital twins as they are typically implements.

### SUMMARY

Various embodiments described herein relate to a method performed by a processor for performing a simulation of a system, the method including one or more of the following: accessing a digital twin stored in memory, wherein the digital twin includes: a plurality of nodes, each node having at least one normalized interface associated with data having a respective data type, and a plurality of edges connecting respective normalized interfaces associated with like data types among the plurality of nodes; propagating data having a first data type through the plurality of nodes along edges of the plurality of edges connected to normalized interfaces associated with the first data type; and extracting data from at least one node of the plurality of nodes to be used as simulation output.

Various embodiments described herein relate to an apparatus for performing a simulation of a system, the apparatus including one or more of the following: a memory storing a definition of a digital twin, wherein the digital twin includes: a plurality of nodes, each node having at least one normalized interface associated with data having a respective data type, and a plurality of edges connecting respective normalized interfaces associated with like data types among the plurality of nodes; and a processor in communication with the memory, the processor being configured to perform a simulation of a system, including: propagating data having a first data type through the plurality of nodes along edges of the plurality of edges connected to normalized interfaces associated with the first data type.

Various embodiments described herein relate to machine-readable non-transitory medium encoded with instructions for execution by a processor, the machine-readable non-transitory medium including one or more of the following: instructions for accessing a digital twin, wherein the digital twin includes: a plurality of nodes, each node having at least one normalized interface associated with data having a respective data type, and a plurality of edges connecting respective normalized interfaces associated with like data types among the plurality of nodes; instructions for propagating data having a first data type through the plurality of nodes along edges of the plurality of edges connected to normalized interfaces associated with the first data type; and instructions for extracting data from at least one node of the plurality of nodes to be used as simulation output.

Various embodiments additionally or alternatively include training the digital twin including one or more of the following: receiving data representing the operation of a real-world system modeled by the digital twin; modifying an activation function of at least one node of the plurality of nodes based on the received data, whereby the operation of the at least node better matches the operation of the real-world system.

Various embodiments additionally or alternatively include determining a control path using the digital twin including one or more of the following: identifying at least one control property of the at least one node; identifying a desired state of a real world system modeled by the digital twin, wherein the desired state may be a point value or a time-series value curve; and tuning the at least one control property to reduce a difference between the desired state and a predicted state predicted by the digital twin based on at least the control property, wherein tuning may include one or more of the following: constructing a cost function including the at least one control property as an independent variable and a cost representing the difference between the desired state and the predicted state as a dependent variable; and preforming an optimization procedure such as gradient descent to locate a value for the at least one control property predicted to minimize or reduce the cost; and using the tuned at least one control property to send a control instruction to the real-world system.

Various embodiments additionally include propagating data having a second data type through the plurality of nodes along edges of the plurality of edges connected to normalized interfaces associated with the second data type.

Various embodiments are described wherein each node of the plurality of nodes includes an activation function, and the step of propagating data includes applying the activation function of a node to the data as the data is propagated through the node.

Various embodiments additionally include repeating the step of propagating data for a number timesteps, wherein the number of timesteps is selected based on the period of time for which simulation is to be performed.

Various embodiments additionally include identifying at least one node of the plurality of nodes that will provide simulation output, and the step of propagating data includes propagating data from other nodes of the plurality of nodes toward the at least one node that will provide simulation output.

Various embodiments are described wherein each node of the plurality of nodes is associated with a property, and additionally including: updating the property of at least one node of the plurality of nodes based on propagating the data, wherein extracting data from the at least one node includes reading the property of the at least one node.

Various embodiments are described wherein each node of the plurality of nodes is labeled according to an ontology to represent an actor within the system, and each data type is labeled according to the ontology to represent a quanta acted on by the system.

Various embodiments described herein relate to a non-transitory machine-readable medium and related method and apparatus including a processor and memory, including one or more of the following: a data arrangement for defining a digital twin, the data arrangement including: a first node having a normalized output interface associated with a data type; a second node having a normalized input interface associated with the data type; and an edge connecting the normalized output interface of the first node to the normalized input interface second node.

Various embodiments are described wherein at least one of the first node and the second node includes an activation function for application to data of the data type.

Various embodiments are described wherein the activation function is a physics-based function that models physics of a real-world system.

Various embodiments are described wherein the activation function is a behavior function simulating the operation of a device represented by at least one of the first node and the second node.

Various embodiments are described wherein the data type represents quanta operated on by a real-world system.

Various embodiments are described wherein the quanta includes at least one of: fluid, thermal, mechanical, fuel, control, and data.

Various embodiments are described wherein at least one of the first node and the second node includes an additional normalized interface associated with the data type.

Various embodiments are described wherein at least one of the first node and the second node includes an additional normalized interface associated with an additional data type.

Various embodiments are described wherein at least one of the first and second nodes store a property associated with the node.

Various embodiments are described wherein the data type includes at least one property associated with data represented according to the data type.

Various embodiments are described wherein the first node and the second node belong to a plurality of nodes, each node having respective normalized interfaces, and the edge belongs to a plurality of edges, each edge connecting at least two normalized interfaces associated with like data types among the plurality of nodes.

Various embodiments are described wherein the data type arranges data in packets for propagation from the first node to the second node.

Various embodiments are described wherein the first node and the second node are labeled according to an ontology that describes a real-world system.

Various embodiments are described wherein the data type is labeled according to an ontology that describes a real-world system.

Various embodiments described herein relate to a method for enabling a user to construct a digital twin and related non-transitory machine-readable medium and apparatus including a processor and memory, including one or more of the following: receiving, from the user: an identification of a first normalized interface to be associated with an element of a digital twin, and an identification of a first data type to be associated with the first normalized interface; and creating a data arrangement representing the digital twin, wherein the data arrangement includes: a set of nodes representing the element, at least one node of the set of nodes including the first normalized interface associated with the first data type.

Various embodiments are described wherein the set of nodes includes only a single node.

Various embodiments are described wherein the set of nodes includes: a first node having the first normalized interface and a second normalized interface associated with a second data type, wherein the second data type is either the same as the first data type or different from the first data type, and a second node having a third normalized interface associated with the second data type; and the data arrangement further includes an edge connecting the second normalized interface to the third normalized interface.

Various embodiments are described wherein receiving the identification of a first data type includes receiving, from the user, a selection of a quanta type from a group of available quanta types.

Various embodiments are described wherein the quanta type includes one of the following: fluid, thermal, mechanical, fuel, control, and data.

Various embodiments additionally include receiving, from the user, an identification of an activation function, wherein the data arrangement stores the activation function as part of the at least one node.

Various embodiments additionally include receiving, from the user: an identification of a first sub-element having a normalized output interface, an identification of a second sub-element having a normalized input interface, the normalized output interface and normalized input interfaces associated with like data types, and the first sub-element and second sub-element forming at least part of the first element, an identification of an edge extending between the normalized output interface and the normalized input interface.

### BRIEF DESCRIPTION OF THE DRAWINGS

In order to better understand various example embodiments, reference is made to the accompanying drawings, wherein:

FIG. 1 illustrates an example system for implementation of various embodiments;

FIG. 2 illustrates an example system for implementing a controller device;

FIG. 3 illustrates an example digital twin for use in various embodiments;

FIG. 4 illustrates an example graphical user interface for enabling a user to define a digital twin.

FIG. 5 illustrates an example of a digital twin for modeling a storage tank according to two levels of detail;

FIG. 6 illustrates an example of a digital twin for modeling a hydronic system according to two levels of detail;

FIG. 7 illustrates an example simulation of a subsystem digital twin;

FIG. 8 illustrates an example hardware device for implementing a controller, server, or other device for defining or utilizing a digital twin;

FIG. 9 illustrates an example method 900 for performing a simulation against a digital twin;

FIG. 10 illustrates an example component digital twin arrangement;

FIG. 11 illustrates a first example interface for composing a component digital twin;

FIG. 12 illustrates a second example interface for composing a component digital twin;

FIG. 13 illustrates a third example interface for composing a component digital twin;

FIG. 14 illustrates a fourth example interface for composing a component digital twin;

FIG. 15 illustrates a first example interface for composing an equipment digital twin; and

FIG. 16 illustrates a second example interface for composing an equipment digital twin.

### DETAILED DESCRIPTION

The description and drawings presented herein illustrate various principles. It will be appreciated that those skilled in the art will be able to devise various arrangements that, although not explicitly described or shown herein, embody these principles and are included within the scope of this disclosure. As used herein, the term, “or,” as used herein, refers to a non-exclusive or (i.e., and/or), unless otherwise indicated (e.g., “or else” or “or in the alternative”). Additionally, the various embodiments described herein are not necessarily mutually exclusive and may be combined to produce additional embodiments that incorporate the principles described herein.

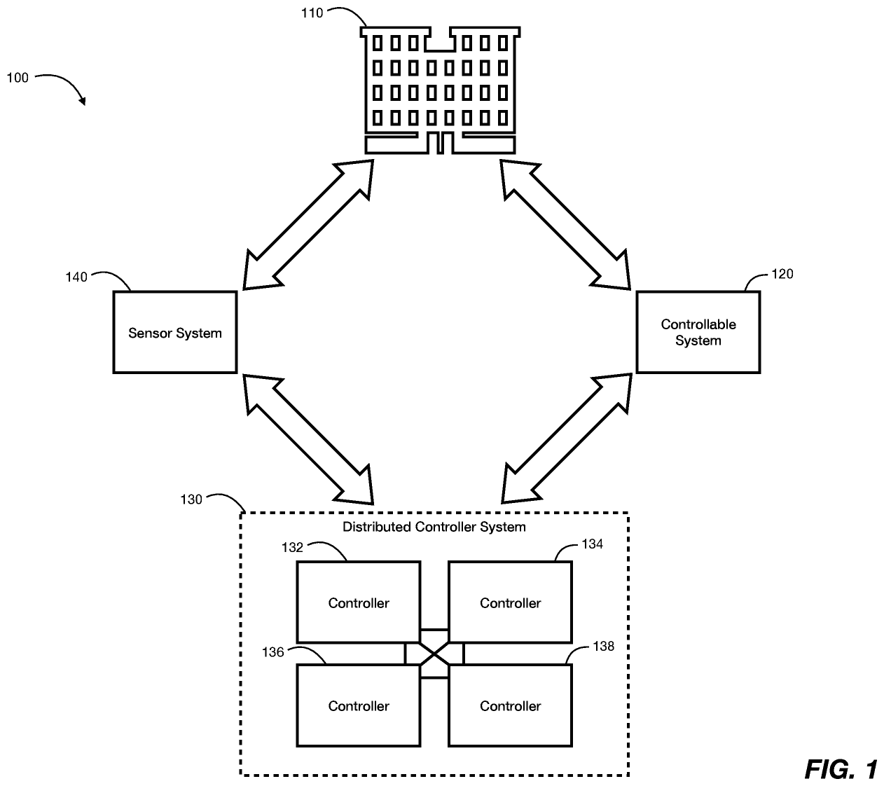

FIG. 1 illustrates an example system 100 for implementation of various embodiments. As shown, the system 100 may include an environment 110, some aspect of which is affected by a controllable system 120. The behavior of the controllable system 120 is, in turn, controlled by a distributed controller system 130. To obtain information useful in making control decisions, the distributed controller system 130 receives data from a sensor system 140 which, in turn, generates its data based on observations from the environment 110.

According to one specific example, system 100 may describe a heating, ventilation, and air conditioning (HVAC) application. As such the environment 110 may be a building whose temperature is to be controlled by the controllable system 120. The controllable system 120 may be the HVAC system itself, which may be controllable to distribute warm or cool air throughout the building 110. Thus, the controllable system 120 may include HVAC equipment such as pumps, boilers, radiators, chillers, fans, vents, etc. The sensor system 140 may include a set of temperature sensors distributed throughout the building 110 to collect and report temperature values.

While various embodiments disclosed herein will be described in the context of such an HVAC application, it will be apparent that the techniques described herein may be applied to other applications including, for example, applications for controlling a lighting system, a security system, an automated irrigation or other agricultural system, a power distribution system, a manufacturing or other industrial system, or virtually any other system that may be controlled. Further, the techniques and embodiments may be applied other applications outside the context of controlled systems. Various modifications to adapt the teachings and embodiments to use in such other applications will be apparent.

As shown, the distributed controller system 130 includes four controllers 132, 134, 136, 138 in communication with one another. The controllers 132, 134, 136, 138 may be located within the environment 110, at another location (such as another environment similar to the environment 110 or in a cloud data center), or some combination thereof. Each controller 132, 134, 136, 138 may be connected to one or more devices, such as individual devices of the controllable system 120 or sensor system 140. Such connection may be direct or indirect (e.g., via one or more intermediate devices such as a network), wired or wireless, or any other type of connection that would enable communication between devices. In some embodiments, each controller 132, 134, 136, 138 may be connected to those devices of the controllable system 120 or sensor system 140 that are physically most proximate to that respective controller 132, 134, 136, 138. For example, where the environment 110 is a building with four floors, the controllers 132, 134, 136, 138 may be installed one on each such floor and then connected to the devices of the controllable system 120 or sensor system 140 physically located on the same floor. Alternatively, devices of the controllable system 120 may be distributed amongst controllers 132, 134, 136, 138 via criteria other than physical proximity, such as demand of the devices on the each controller 132, 134, 136, 138.

The controllers 132, 134, 136, 138 may be identical to each other or may employ different hardware or software. For example, two controllers 132, 134 may be full featured controllers while the other two controllers 136, 138 may be satellite controllers with limited capabilities with respect to the full featured controllers. As another example, one or more of the controllers 132, 134, 136, 138 may be specialized in one or more respects, deployed to work on only a subset of tasks associated with controlling the controllable system 120. As such, the controllers 132, 134, 136, 138 may implement partial or full redundancy of functionality or may divide functionality among themselves (either by pre-installation component design or by post-installation coordination or agreement) to achieve a fully functional distributed controller system 130. While the teachings and embodiments disclosed herein will be described with respect to fully-redundant, fully-featured controllers 132, 134, 136, 138 (unless otherwise noted), modifications for applications of the teachings and embodiments for application to such alternative controller 132, 134, 136, 138 arrangements will be apparent. It will also be apparent that other embodiments may include a greater or fewer number of controllers. In some such embodiments, the system 100 may include only a single controller, rather than multiple controllers cooperating in a distributed manner. Various modifications in such alternative embodiments will be apparent.

Various methods for implementing a distributed controller system 130 may be employed for coordinating the functions of the controllers 132, 134, 136, 138. For example, the controllers 132, 134, 136, 138 may coordinate to elect a single controller 132, 134, 136, 138 to take the function of leader controller, while the remaining controllers 132, 134, 136, 138 become follower controllers. In such an arrangement, each follower controller may perform some limited functionality, such as receiving sensor data from those devices in the sensor system 140 attached to that follower controller, committing such sensor data 226 to a database available to the other controllers 132, 134, 136, 138, ensuring proper connections and operation of devices of the controllable system 120 attached to that follower controller, performing fault detection for one or more field devices 296, or calculating derived “sensor” or otherwise predicting data for areas or components where direct observation (e.g., via a physical sensor device) is not possible.

Meanwhile, the elected leader controller may be responsible for additional functionality such as, for example, training machine learning models, running simulations, and making control decisions for the controllable system 120. In some embodiments, the elected leader controller may rely on the remaining controllers 132, 134, 136, 138 to assist in the performance of these tasks by distributing work among the follower controllers according to various distributed work paradigms that may be employed. For example, the leader controller may break a task to be performed into multiple smaller steps or work packages, transmit the steps or work packages to the follower controllers for performance, receive the sub-results of the steps or work packages back when the work is completed, and use the sub-results to arrive at an ultimate result (e.g., a further trained model, a completed simulation or set of simulations, or a control decision). With regard to control decisions or other actions involving communication with devices of the controllable system 120 or the sensor system 140, the leader controller may determine to which of the controllers 132, 134, 136, 138 the device is connected and send the communication to that controller 132, 134, 136, 138 to then be passed on to the intended device.

It will be understood that FIG. 1 may represent a simplification in some respects. For example, in some embodiments, one or more devices may be both a controllable device (belonging to the controllable system 120) and a sensor device (belonging to the sensor system 140). For example, a controllable pump may have an integrated sensor that reports an observed pressure back to the distributed controller system 130. In some embodiments, there may be multiple controllable systems 120, multiple sensor systems 140, or other systems (not shown) involved in implementing the overall system 100, each of which may or may not be in communication with the distributed controller system 130. For example, the distributed controller system 130 may control both an HVAC system and a lighting system, which may be implemented as two independent controllable systems 120. As another example, the distributed controller system 130 may obtain sensor data from both a set of sensors the distributed controller system 130 manages as well as a set of sensors managed by a third party service (e.g., as may be made available through an API or other network-based service) and, as such, there may be multiple independent sensor systems 140 that inform the operation of the distributed controller system 130. In some embodiments, the distributed controller system 130 may manage controllable systems 120 for multiple environments 110 (e.g., the HVAC systems for two or more separate buildings) or may be in communication with other distributed controller systems 130 associated with implementations of systems similar to system 100 for other environments 110 (e.g., to extend the processing capacity through distribution of work to additional controllers, to execute multi-building control actions, or to gather information from other environments such as predicted power usage). Thus, where the environment 110 is a building, one or more distributed controller systems 130 may implement not only a “smart building” but a “smart city” of multiple buildings coordinating their operations. Various modifications for replicating or otherwise adapting the teachings herein across additional environments, controllable systems, distributed controller systems, or sensor systems will be apparent.

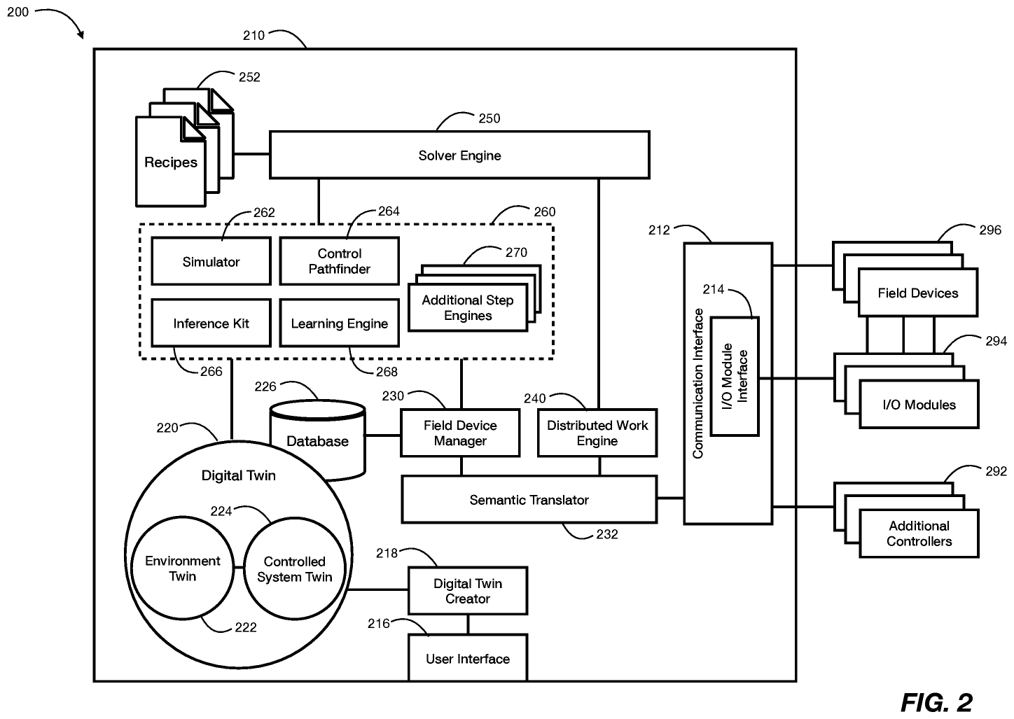

FIG. 2 illustrates an example system 200 for implementing a controller device 210. The controller device 210 may correspond to one of the controllers 132, 134, 136, 138 of the example system 100 and, as such, may communicate with additional controllers 292 (which may correspond to the remaining controllers 132, 134, 136, 138) to implement a distributed controller system such as the distributed controller system 130. In other embodiments, where only a single controller 210 is used, the additional controllers 292 may not be present. In some embodiments, the controller 210 may be or include a building automation system (BAS) or building management system (BMS).

The controller 210 also communicates with multiple field devices 296. These field devices 296 may correspond to one or more devices belonging to the controllable system 120 or sensor system 140 of the example system 100. Similarly, other field devices 296 may communicate with the additional controllers 292. As such, the field devices 296 may include devices that may be controlled to affect some state of an environment (e.g., HVAC equipment that cooperate to manage a building temperature) or sensor devices that report back information about the environment (e.g., temperature sensors deployed among the different environmental zones of the building).

As noted above, virtually any connection medium (or combination of media) may be used to enable communication between the controller 210 and the additional controllers 292 or field devices 296, including wired, wireless, direct, or indirect (i.e., through one or more intermediary devices, such as in a network) connections. As used herein, the term “connected” as used between two devices will be understood to encompass any form of communication capability between those devices. To enable such connections, the controller 210 includes a communications interface 212. As will be explained in greater detail below, the communication interface 212 may include virtually any hardware for enabling connections with additional controllers 292 or field devices 296, such as an Ethernet network interface card (NIC), WiFi NIC, or USB connection.

In some embodiments, one or more connections to other devices may be supported by one or more I/O modules 294. The I/O modules 294 may provide further hardware or software used in controlling or otherwise communicating with field devices 296 having specific protocols or other particulars for such communication to occur. For example, where a field device 296 includes a motor to be controller, an I/O module 294 having components such as a motor control block, motor drivers, pulse width modulation (PWM) control, or other components relevant to motor control may be used to connect that field device 296 to the controller 210. Various additional components for inclusion in different I/O modules 294 for control of different particular field devices 296. Additional features, such as current or voltage monitoring or overcurrent protection may also be incorporated into the I/O modules 294. To enable communication with the I/O modules 294, the communication interface 212 may include an I/O module interface 214. In various embodiments, the I/O module interface 214 may be a set of electrical contacts for contact with complementary pins of the I/O modules 294. A communication protocol, such as USB, may be implemented over such contacts and pins to enable passing of information between the controller 210 and I/O modules 294. In other embodiments, the I/O module interface 314 may include the same interfaces previously described with respect to the communication interface. In various alternative embodiments, on the other hand, some or all of these more particular components may be incorporated into the controller 210 itself, and some or all of the I/O modules 294 may be omitted from the system 200. Various additional techniques for implementing an I/O module 294 according to various embodiments, may be described in U.S. Pat. Nos. 11,229,138; and 11,706,891, the entire disclosures of which are hereby incorporated herein by reference.

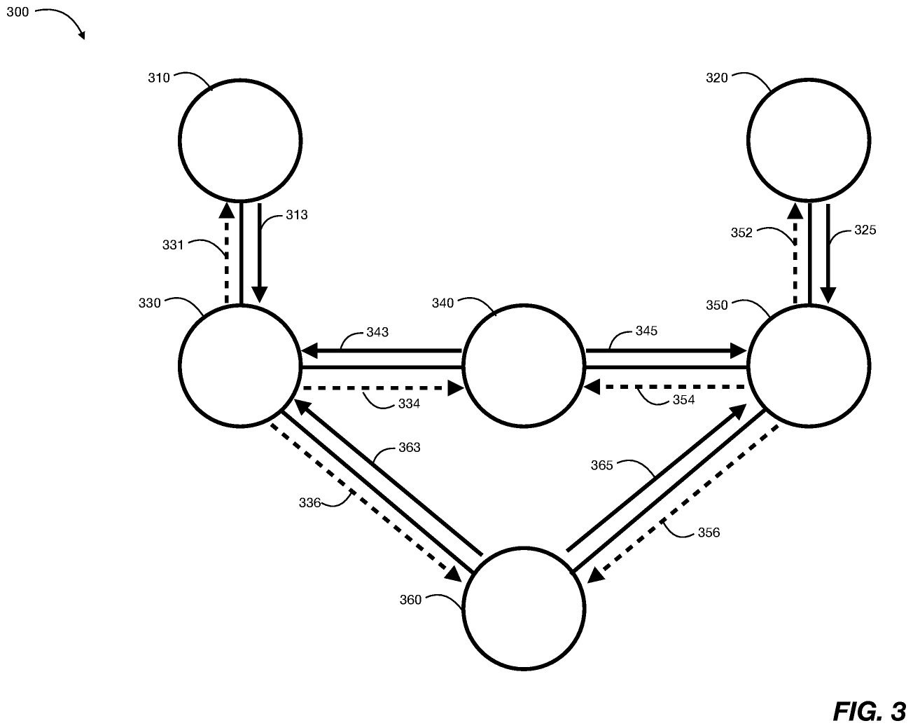

According to various embodiments, the controller 210 utilizes a digital twin 220 that models at least a portion of the system it controls and may be stored in a database 226 along with other data. As shown, the digital twin 220 includes an environment twin 222 that models the environment whose state is being controlled (e.g., a building) and a controlled system twin 224 that models the system that the controller 210 controls (e.g., an HVAC equipment system). A digital twin 220 may be any data structure that models a real-life object, device, system, or other entity. Examples of a digital twin 220 useful for various embodiments will be described in greater detail below with reference to FIG. 3. While various embodiments will be described with reference to a particular set of heterogeneous and omnidirectional neural network digital twins, it will be apparent that the various techniques and embodiments described herein may be adapted to other types of digital twins. Further, while the environment twin 222 and controlled system twin 224 are shown as separate structures, in various embodiments, these twins 222, 224 may be more fully integrated as a single digital twin 220. In some embodiments, additional systems, entities, devices, processes, or objects may be modeled and included as part of the digital twin 220.

In various embodiments, a user may create or modify the digital twin 220. In such embodiments, the controller 210 may include a user interface 216 through which the user accesses a digital twin creator 218 to create or modify the digital twin 220. For example, the user interface 216 may include a display, a touchscreen, a keyboard, a mouse, or any device capable of performing input or output functions for a user. In some embodiments, the user interface 216 may instead or additionally allow a user to use another device for such input or output functions, such as connecting a separate tablet, mobile phone, or other device for interacting with the controller 210.

The digital twin creator 218 may provide a toolkit for the user to create digital twins 220 or portions thereof. For example, the digital twin creator 218 may include a tool for defining the walls, doors, windows, floors, ventilation layout, and other aspects of a building construction to create the environment twin 222. The tool may allow for definition of properties useful in defining a digital twin 220 (e.g., for running a physics simulation using the digital twin 220) such as, for example, the materials, dimensions, or thermal characteristics of elements such as walls and windows. Such a tool may resemble a computer-aided drafting (CAD) environment in many respects. According to various embodiments, unlike typical CAD tools, the digital twin creator 218 may digest the defined building structure into a digital twin 220 model that may be computable, trainable, inferenceable, and queryable, as will be described in greater detail below.

In addition or alternative to building structure, the digital twin creator 218 may provide a toolkit for defining virtually any system that may be modeled by the digital twin 220. For example, for creating the controlled system twin 224, the digital twin creator 218 may provide a drag-and-drop interface where various HVAC equipment (e.g., boilers, pumps, valves, tanks, etc.) may be placed and connected to each other, forming a system (or a group of systems) that reflect the real world controllable system 120. In some embodiments, the digital twin creator 218 may drill even further down into definition of twin elements by, for example, allowing the user to define individual pieces of equipment (along with their behaviors and properties) that may be used in the definition of systems. As such, the digital twin creator 218 provides for a composable twin, where individual elements may be “clicked” together to model higher order equipment and systems, which may then be further “clicked” together with other elements.

In other embodiments, the digital twin 220 may be created by another device (e.g., by a server providing a web- or other software-as-a-service (SaaS) interface for the user to create the digital twin 220, or by a device of the user running such software locally) and later downloaded to or otherwise synced to the controller 210. In other embodiments, the digital twin 220 may be created automatically by the controller 210 through observation of the systems it controls or is otherwise in communication with. In some embodiments a combination of such techniques may be employed to produce an accurate digital twin—a first user may initially create a digital twin 220 using a SaaS service, the digital twin 220 may be downloaded to the controller 210 where a second user further refines or extends the digital twin 220 using the digital twin creator 218, and the controller 210 in operation may adjust the digital twin 220 as needed to better reflect the real observations from the systems it communicates with. Various additional techniques for defining, digesting, compiling, and utilizing a digital twin 220 according to some embodiments may be described in U.S. Pat. Nos. 10,708,078; and 10,845,771; and U.S. patent application publication numbers 2021/0383200; 2021/0383235; and 2022/0215264, the entire disclosures of which are hereby incorporated herein by reference.

In addition to storing the digital twin 220, the database 226 may store additional information that is used by the controller 210 to perform its functions. For example, the database 226 may hold tables that store sensor data collected from field devices 296 or control actions that should be issued to field devices 296. Various additional or alternative information for storage in the database 226 will be apparent. In various embodiments, the database 226 implements database replication techniques to ensure that the database 226 content is made available to the additional controllers 292. As such, changes that the controller 210 makes to the database 226 content (including the digital twin 220) may be made available to each of the controllers 292, while database changes made by the additional controllers 292 are similarly made available in the database 226 of the controller 210 as well as the other additional controllers 292.

A field device manager 230 may be responsible for initiating and processing communications with field devices 296, whether via I/O modules 294 or not. As such the field device manager 230 may implement multiple functions. For sensor management, the device manager 230 may receive (via the communication interface 212 and semantic translator 232) reports of sensed data. The field device manager 230 may then process these reports and place the sensed data in the database 226 such that it is available to the other components of the controller 210. In managing sensor devices, the field device manager 230 may be configured to initiate communications with the sensor devices to, for example, establish a reporting schedule for the sensor devices and, where the sensor devices form a network for enabling such communications, the network paths that each sensor device will use for these communications. In some embodiments, the field device manager 230 may receive (e.g., as part of sensor device reports) information about the sensor health and then use this information to adjust reporting schedule or the network topology. For example, where a sensor device reports low battery or low power income, the controller 210 may instruct that sensor device to report less frequently or to move to a leaf node of the network topology so that its power is not used to perform the function of routing messages for other sensors with a better power state. Various other techniques for managing a group or swarm of sensor devices will be apparent.

The field device manager 230 may also be responsible for managing and verify the connections of field devices 296 to the I/O modules 294. For example, configuration data stored in the digital twin 220 or elsewhere in the database 226 may indicate that a particular field device 296 is expected to be connected to a particular I/O module 294 having a particular set of supporting components, that the particular I/O module 294 is expected to be connected to a particular I/O module interface 214, and that communications through the particular I/O module 294 are expected to occur according to a particular set of protocols. The field device manager 230 may test (e.g., by sending one or more test communications) that the particular field device 296 is actually set up according to these configurations (e.g., if communications are successful or not) and then take remedial action if there is an installation problem. In some cases, the field device manager 230 may simply update the configuration information if doing so will solve the incorrect installation (e.g. the I/O module 294 is connected to a different I/O module interface 214 but is otherwise working, the I/O module 294 is configured to communicate according to a different protocol). In other cases, the field device manager 230 may prompt a user that these is an issue with the connection and ask for the user to take remedial action (e.g., reconfigure settings at the controller 210 or physically relocate, replace, or otherwise reinstall an I/O module 294, connection wires, or the field device 296). As such, the field device manager 230 in some embodiments provides a software toolset for the user via the user interface 216, a web portal, or elsewhere. In some embodiments, such a user interface 216 may be a graphical representation of the controller 210, I/O modules 294, and field device 296 connections thereto that allows the user to see how these devices are expected by the controller 210 to be installed. In some embodiments, the toolset may also allow the user to reconfigure these expectations rather than physically changing the system of devices (e.g., by dragging an I/O module graphic to a different connection graphic, or by changing a connection type for one or more wiring terminal graphics of an I/O module graphic).

In some embodiments, in addition to the verification of I/O module 294 connections, the field device manager 230 may perform a fuller commissioning procedure. For example, the field device manager 230 may perform a series of tests on the field devices 296 that are connected to the controller 210 or on the full set of field devices 296 in the controllable system 120 or the sensor system 140 (particularly where the controller 210 has been elected as a leader controller). Accordingly, in some such embodiments, the field device manager 230 may communicate with the field devices 296 via the communication interface 212 to perform tests to verify that installation and behavior is as expected (e.g., as expected from simulations run against the digital twin 220 or from other configurations stored in the database 226 or otherwise available to the controller 210). Where the field device manager 230 drives testing of field devices 296 attached instead to one or more additional controllers 292, the testing may include communication with the additional controllers 292 (e.g., through use of the distributed work engine 240 or directly through the communications interface 212), such as test messages that the additional controllers 292 route to their connected field devices 296 or instructions for the additional controllers 292 to perform testing themselves and report results thereof.

In some embodiments, the testing performed by the field device manager 230 may be defined in a series of scripts, preprogrammed algorithms, or driven by artificial intelligence (examples of which will be explained below). Such tests may be very simple (e.g., “can a signal be read on a wire,” or “does the device respond to a simple ping message”), device specific (e.g., “is the device reporting errors according to its own testing,” “is the device reporting meaningful data,” “does the device successfully perform a test associated with its device type”), driven by the digital twin 220 (“does this device report expected data or performance when this other equipment is controlled in this way,” “when the device is controlled this way, do other devices report expected data”), at a higher system level (“does this zone of the building operate as expected,” “do these two devices work together without error”), or may have any other characteristics for verifying proper installation and functioning of a number of devices both individually and as part of higher order systems.

In some embodiments, a user may be able to define (e.g., via the user interface 216) at least some of the commissioning tests to be performed. In some embodiments, the field device manager 230 presents a graphical user interface (GUI) (e.g., via the user interface 216) for giving a user insight into the commissioning procedures of the field device manager 230. Such a GUI may provide an interface for selecting or otherwise defining testing procedures to be performed, a button or other selector for allowing a user to instruct the field device manager 230 to begin a commissioning process, an interface showing the status of an ongoing commissioning process, or a report of a completed commissioning process along with identification of which field devices 296 passed or failed commissioning, recommendations for fixing failures, or other useful statistics.

In some embodiments, the data generated by a commissioning process may be useful to further train the digital twin 220. For example, if activating a heating radiator does not cool a room as much as expected, there may be a draft or open window in the room that was not originally accounted for that can now be trained intro the digital twin 220 for improved performance. As such, in some embodiments, the field device manager 230 may log the commissioning data in a form useful for the learning engine 268 to train the digital twin 220, as will be explained in greater detail below.

In some embodiments, the field device manager 230 may also play a role in networking. For example, the field device manager 230 may monitor the health of the network formed between the controller 210 and the additional controllers 292 by, for example, periodically initiating test packets to be sent among the additional controllers 292 and reported back, thereby identifying when one or more additional controllers 292 are no longer reachable due to, e.g., a device malfunction, a device being turned off, or a network link going down. In a case where one of the additional controllers 292 had been elected leader, the field device manager 230 may call for a new leader election among the remaining reachable additional controllers 292 and then proceed to participate in the election according to any of various possible techniques.

With respect to runtime control of the field devices 296, while other components (such as the control pathfinder 264) may decide what control actions are to be taken and make them available to other components (e.g., by writing the desired actions to the database 226), the field device manager 230 may be responsible for issuing the commands to the field devices 296 that cause the desired action to occur. In some embodiments, where the controller 210 is elected leader controller, the field device manager 230 may issue commands not only to the field devices 296 connected to the controller 210 but also to the additional controllers 292. In other embodiments where the database 226 is available to multiple controllers 210, 292 (e.g., through database replication techniques, by allowing the additional controllers 292 to query the database 226 of the controller 210, or by making the database 226 available on a different accessible server) the respective field device managers 230 or analogous components of the additional controllers 292 may similarly notice updates to the desired control actions and issue commands to their respective attached field devices 296 to effect the desired controls. Various additional techniques for implementing a field device manager 230 according to various embodiments may be described in U.S. Pat. Nos. 11,477,905; 11,596,079; and U.S. patent application publication numbers 2022/0067226; 2022/0067227; 2022/0067230; and 2022/0070293, the entire disclosures of which are hereby incorporated herein by reference.

Various embodiments utilize a higher order language to direct operations internal to the controller 210 and additional controllers 292. As an example, while field devices 296 may be controlled or otherwise communicate according to various diverse semantics and protocols (e.g., BACnet, Modbus, Wirepas, Pulse-Width Modulation, Frequency Modulation, 1-Wire, Bluetooth Low Energy Mesh, Ethernet, WiFi, 24 VAC, Voltage signal, Current signal, Resistance signal, the higher order language itself, etc.), desired actions identified by the control pathfinder 264, written to the database 226, or issued by the field device manager 230 may be agnostic to these particular differences. As another example, while the actions that the field devices 296 can perform may be differentiated based on the characteristics of a device (a pump can be instructed to pump fluid, a fan can be instructed to spin), these actions may be abstracted (or semantically raised) into the same action (either of these devices may be instructed to cause quanta to move). Thus, when a BACnet pump is to be instructed to begin pumping fluid, rather than issuing a specific BACNet command that will activate that pump or issuing an instruction for the pump to begin pumping, the field device manager 230 may issue a command that the particular “transport” field device 296 begin to move quanta from its input to its output. Such a higher order language may be reflective of the high order at which the digital twin 220 is defined, as will be explained in greater detail below.

While some field devices 296 may natively understand the higher order language, others may still require communication according to their own native protocols. A semantic translator 232 may thus be responsible for translating higher order language communications received from the field device manager 230 or distributed work engine 240 into the appropriate lower level, protocol specific messages that will be sent via the communication interface 212. So, where the field device manager 230 issues a command for a particular transport field device 296 to begin moving quanta, the semantic translator 232 may semantically lower this command to a command for a pump to begin pumping fluid (or for a fan to begin spinning, etc., depending on the specifics of the device as may be defined in the digital twin 220) and then semantically translate this command to a BACnet message (or Modbus, etc., depending on the specifics of the device as may be defined in the digital twin 220) that will accomplish the lowered action. The semantic translator 232 may then transmit the fully-formed message to the appropriate recipient device via the communications interface 212. Thus, while the digital twin 220 and other internal components of the controller 210, may operate according to a semantically-raised language (which may be driven by a semantic ontology used in the digital twin 220), the digital twin 220 may additionally store information for the various field devices 296 useful in semantically lowering and translating this language to enable effective communication with the field devices 296. In various embodiments, the semantic translator 232 may work in the opposite direction as well, translating and raising incoming messages from the field devices 296, such that they may be interpreted and acted on according to the semantically raised language of the controller 210. Various techniques for implementing a semantic translator 232, a digital twin 220 ontology, or an internal semantically-raised language according to some embodiments may be disclosed in U.S. patent application publication numbers 2022/0066754; and 2022/0066761, the entire disclosures of which are incorporated herein by reference.

As shown, the controller 210 includes a distributed work engine 240 for guiding the distributed operation of the controller 210 with additional controllers 292. As such, the distributed work engine 240 may receive computation steps (e.g., from the solver engine 250) to be outsourced to other controllers 292, transmit the work (via the semantic translator 232 or communication interface 292) to the additional controllers 292, receive work results back, and pass them back to the solver engine 250. Such a workflow may be used when, for example, the controller 210 has been elected as a leader controller. The distributed work engine 240 may also implement the other side by receiving work requests from one or more additional controllers 292, passing the work requests to the solver engine 250 or directly to a step engine 260, receiving the result of the work, and transmitting the result back to the requesting controller 292. Such a workflow may be used when, for example, the controller 210 has been not elected as a leader controller and is, instead, a follower controller. In various alternative embodiments, the controller 210 may both issue work requests to other controllers 292 and execute work requests received from additional controllers 292, regardless of status as a leader or follower (if any). The distributed work engine 240 may perform additional functionality associated with managing a distributed compute system such as, for example, selecting particular ones of the additional controllers 292 to receive particular work requests, receiving load metrics or otherwise assessing compute health/capacity of the additional controllers 292, performing load balancing among the additional controllers 292, and deciding when to resend or reassign previously issued work requests, and when to time out previously issued work requests (too much time has elapsed, a sufficient number of other responses have been received, etc.) and instruct the solver engine 250 to move on with the next steps of a computation. Various additional techniques for implementing a distributed work engine 240 according to some embodiments may be described in U.S. Pat. No. 11,490,537, the entire disclosure of which is hereby incorporated herein by reference.

A solver engine 250 may be responsible for driving many, if not all, of the higher order functions of the controller 210 such as, for example, running simulations, deciding on control actions to be taken, causing the digital twin 220 to learn from observations, etc. To effect such actions, the solver engine 250 may execute various recipes 252 (which may be stored in the database 226 or elsewhere) that define a sequence of steps to be performed by separate step engines 260. Accordingly, the solver engine 250 may identify a recipe to be executed (e.g., based on manual selection of a recipe 252 for execution by a user, invocation of a recipe 252 by step engine 260, identification by the step of another recipe 252 under execution, a scheduled time for a recipe 252, a timer elapsing since the past execution of the recipe 252, or the occurrence of some trigger event associated with the recipe 252). The solver engine 250 may then begin to “walk through” the steps of the recipe 252, identifying an appropriate step engine 260 to perform the step, issuing the step to that step engine 260, receiving the result after the step engine 260 has completed its work, and then move on to the next step of the recipe 252. In some embodiments, the solver engine 250 may itself be adapted to perform some steps. The solver engine 250 may then iterate on this process until it reaches the end of the recipe 252.

In some cases, the solver engine 250 may decide that one or more steps of a recipe 252 are to be outsourced to another controller 292. For example, the recipe 252 itself may specify that a step is to be performed by another controller 292, the solver engine 250 may determine that local processing capacity is not sufficient to perform a step, or the solver engine may encounter multiple parallel steps in a recipe 252 and decide to perform only one or a subset locally while outsourcing the rest.

The step engines 260 may include a number of varying functions that can be relied on by the recipes 252 and solver engine 250 to perform various steps of a larger task. As shown, the step engines 260 include a simulator 262, a control pathfinder 264, and inference kit 266, a learning engine 268, and one or more additional step engines 270. It will be apparent that fewer, additional, or different step engines 270 may be included depending on the functions to be performed by the controller 210 (e.g., as may be defined in the recipes 252) and as appropriate to adapting the controller 210 for use in different applications.

The simulator 262 may be configured to simulate the behavior of the system 100 into the future or under alternative/hypothesis conditions. To accomplish such a simulation, the simulator 262 may execute a sequence of time steps (e.g., simulating the state of the digital twin 220 a minute into the future at a time) until the future time is reached and state can be read from the digital twin 220. For example, to simulate the temperature of a zone one hour into the future, the simulator 262 may propagate heat from all heat sources through the digital twin 220 one minute at a time, sixty times, and then read the temperature of the zone from the digital twin 220. The use of the digital twin 220 to perform such simulations will be explained in greater detail below. In various embodiments, the simulator 262 may actually encompass multiple more specific simulator step engines. For example, the simulator 262 may include separate simulators for simulating state of the building, operating of equipment, occupancy of different zones of the building, and the impact of weather or other external factors on the state of the system 100. The simulator 262 (or other step engines 260) may make use of the digital twin in different manners. In some cases, the simulator 262 may retrieve a precompiled (e.g., at the time of initial digital twin creation) digital twin 220, place it in memory, populate relevant data into it, and use the data that is produced as simulation output. In other cases, the simulator 262 may alter portions of the digital twin 220 description at the time of simulation (e.g., adding or removing equipment, or changing equipment parameters), compile the digital twin at that point in time, place the newly-compiled twin in memory, and then run its simulation. Thus, the digital twin 220 may include both a data description of the systems being modeled as well as compiled and functional versions of that data description.

The control pathfinder 264 may be configured to identify, using the digital twin 220, one or more control actions to be performed be the field devices 296 to reach a desired state. For example, the control pathfinder 264 may analyze multiple possible candidate control schemes against the digital twin 220 to determine which candidate control scheme best produces the desired state in the digital twin 220 and then write the control actions from that scheme to the database 226 for the field device manager 230 to act on. In some embodiments, the control pathfinder 264 may leverage the simulator 262 to perform its task (and likewise, step engines 260 may in some embodiments generally invoke each other when useful to the performance of their task).

In other embodiments, the control pathfinder 264 may utilize auto-differentiation and gradient descent to identify an appropriate control scheme to reach a desired state in the digital twin 220. As will be explained in greater detail below, through auto-differentiation, the digital twin 220 may be established as omnidirectional; that is, while activation functions may be defined or learned in a forward direction, their partial derivatives may be used to define “activation functions” in the reverse direction, thereby enabling traversal of the digital twin 220 in any direction and along any path desired. When paired with differentiable programming to define the digital twin 220 (particularly, its activation functions), such partial derivatives may be made available in the digital twin 220 with little-to-no additional compute cost. From here, the control pathfinder 264 may generate a cost function on the digital twin 220 that relates a set of input variables (e.g., possible control variables) to a cost—the distance between the predicted state values and the desired state values. The control pathfinder 264 may then employ gradient descent to identify a control scheme likely to produce the desired state in the environment 110 (or a state acceptably close to the desired state).

Various additional, alternative, or modified methods may be used by the control pathfinder 264 to locate a control path. For example, in some embodiments, the control pathfinder 264 may employ multiple gradient descent agents (e.g., as a Self-Organizing Migrating Algorithm or SOMA) to improve the likelihood of locating a global minimum of the cost function, rather than a local minimum representing a sub-optimal solution control scheme. In some embodiments, a simpler neural network trained against the digital twin 220 for a reduced problem may be used by the control pathfinder 264 to find a control scheme quickly which is then tested and refined against the digital twin 220 or written directly to the database so that the field devices 296 may be controlled immediately. In some embodiments, the control pathfinder 264 may employ more than one of these and other approaches in an ensemble or adversarial approach to find optimal control schemes. Various additional techniques that may be used in implementing a simulator 262, control pathfinder 264, other step engines 260, or other aspects of the controller 210 according to some embodiments may be described in U.S. Pat. Nos. 10,705,492; 10,921,760; U.S. patent application publication numbers 2021/0381712; 2021/0382445; 2021/0383042; and 2021/0383219, the entire disclosures of which are hereby incorporated herein by reference.

The inference kit 266 may be configured to draw information from the digital twin 220 for use in driving decisions. As such, the inference kit 266 may enable reading of values from the digital twin 220 and transformation of such values into derived properties and other values (e.g., reading heat and humidity values and sending them through a transformation to produce a comfort value). In various embodiments, the inference kit 266 may provide more advanced inferencing such as performing sensor fusion and defining “virtual sensors” to enable simulation of additional state values at locations where there are not sensors in the real world system 100 from which to draw information. Various techniques for implementing an inference kit 266 according to some embodiments may be disclosed in U.S. patent application publication number 2021/0383236, the entire disclosure of which is hereby incorporated herein by reference.

The learning engine 268 may be configured to train machine learning models for the benefit of the controller 210. For example, in various embodiments, the digital twin 220 itself is trainable. As such, the learning engine 268 may periodically use one or more training examples and machine learning approaches (such as supervised learning and gradient descent) to train the digital twin's 220 activation functions to better model the observed real world system. Such training examples may be drawn from the database 226 (e.g., from sensor data placed there by the field device manager 230 or additional controllers 292). In some embodiments, the learning engine 268 may train additional neural networks, deep learning networks, or other machine learning models based on the simulations (e.g., as may be run by the simulator 262). As such, the learning engine 268 may include a training archivist that captures simulated cases during execution of a recipe 252 and stores them as training examples in the database 226. The learning engine 268 may later used these training examples to train these simple models for later use. Thus, in various embodiments, the learning engine 268 trains the digital twin 220 based on real world observed data and then trains simple models based on the operation of the digital twin 220. Various additional techniques for implementing a learning engine 268 according to some embodiments may be disclosed in U.S. patent application publication number 2021/0383041, the entire disclosure of which is hereby incorporated by reference herein.

As noted, the step engines 260 may include additional step engines 270 as appropriate to the recipes 252 and application of the controller 210. For example, the additional step engines 270 may include an ontological reasoner (which may use various techniques to simplify the digital twin 220 to only those portions relevant to a particular task, thereby reducing processing resources needed), an occupant process (which may take into account occupant comfort needs or desires to guide the determination of a desired state in a system), a weather process (which may make or otherwise obtain weather forecasts), and other engines. Various additional step engines 270 that may be useful will be apparent. Various additional techniques for implementing such additional step engines 270 according to some embodiments may be described in in U.S. Pat. Nos. 10,969,133; and 11,553,618, the entire disclosures of which are hereby incorporated herein by reference.

It will be apparent that, while particular components are shown connected to one another, this may be a simplification in some regards. For example, components that are not shown as connected may nonetheless interact. For example, the user interface 216 may provide a user with some access to the recipes 252 or field device manage 230. Furthermore, in various embodiments, additional components may be included and some illustrated components may be omitted. In various embodiments, various components may be implemented in hardware, software, or a combination thereof. For example, the communications interface 212 may be a combination of communications protocol software, wired terminals, a radio transmitter/receiver, and other electronics supporting the functions thereof. As another example, the solver engine 250 and step engines 260 may be implemented as software running on a processor (not shown) of the controller 210, while the digital twin 220 may be a data structure stored in the database 226 which, in turn, may include memory chips and software for managing database organization and access. Various other implementation details will be apparent and various techniques for implementing a controller 210 and various components thereof according to some embodiments may be described in U.S. patent application publication numbers 2022/0066432; 2022/0066722; U.S. provisional patent applications 62/518,497; 62/704,976; and 63/070,460 the entire disclosures of which are hereby incorporated herein by reference.

It will be further apparent that various techniques described herein may be utilized in contexts outside of controller devices. For example, various techniques may be adapted to project planning tools, report generation, reporting dashboards, simulation software, modeling software, computer aided drafting (CAD) tools, predictive maintenance, performance optimization tools, or other applications. Various modifications for adaptation of such techniques to other applications and domains will be apparent.

FIG. 3 illustrates an example digital twin 300 for use in various embodiments. The digital twin 300 may correspond, for example, to the digital twin 220, the environment twin 222, or the controlled system twin 224 of FIG. 2. As shown, the digital twin 300 includes a number of nodes 310, 320, 330, 340, 350, 360 connected to each other via edges. As such, the digital twin 300 may be arranged as a graph, such as a neural network. In various alternative embodiments, other arrangements may be used. Further, while the digital twin 300 may reside in storage as a graph type data structure, it will be understood that various alternative data structures may be used for the storage of a digital twin 300 as described herein. The nodes 310, 320, 330, 340, 350, 360 may correspond, for example, to aspects of the environment 110 such as HVAC zones, walls, windows, external forces (such as weather); aspects of the sensor system 130 such as individual sensors; aspects of the controllable system 120 such as controllable HVAC equipment; virtual entities, such as HVAC zone subdivisions or virtual sensors that may be assigned values through sensor fusion; or other aspects that may be used in a simulation. The edges between the nodes 310, 320, 330, 340, 350, 360 may, then, represent some relationship between the system aspects represented by the nodes 310, 320, 330, 340, 350, 360; an edge may represent, for example, physical proximity or relative location, proximity or relative location within a control loop of a system, or another relationship.

According to various embodiments, the digital twin 300 is a heterogenous neural network. Typical neural networks are formed of multiple layers of neurons interconnected to each other, each starting with the same activation function. Through training, each neuron's activation function is weighted with learned coefficients such that, in concert, the neurons cooperate to perform a function. The example digital twin 300, on the other hand, may include a set of activation functions 313, 325, 343, 345, 363, 365 that are, even before any training or learning, differentiated from each other, i.e., heterogenous. In various embodiments, the activation functions 313, 325, 343, 345, 363, 365 may be assigned based on domain knowledge related to the system being modeled. For example, the activation functions 313, 325, 343, 345, 363, 365 may include appropriate heat transfer functions for simulating the propagation of heat through a physical environment (such as function describing the radiation of heat from or through a wall of particular material and dimensions to a zone of particular dimensions). As another example, activation functions 313, 325, 343, 345, 363, 365 may include functions for modeling the operation of an HVAC system at a mathematical level (e.g., modeling the flow of fluid through a hydronic heating system and the fluid's gathering and subsequent dissipation of heat energy). Such functions may be referred to as “behaviors” assigned to the nodes 310, 320, 330, 340, 350, 360. In some embodiments, each of the activation functions 313, 325, 343, 345, 363, 365 may in fact include multiple separate functions; such an implementation may be useful when more than one aspect of a system may be modeled from node-to-node. For example, each of the activation functions 313, 325, 343, 345, 363, 365 may include a first activation function for modeling heat propagation and a second activation function for modeling humidity propagation. In some embodiments, these diverse activation functions along a single edge may be defined in opposite directions. For example, a heat propagation function may be defined from node 310 to node 330, while a humidity propagation function may be defined from node 330 to node 310. In some embodiments, the diversity of activation functions may differ from edge to edge. For example, one activation function 313 may include only a heat propagation function, another activation function 343 may include only a humidity propagation function, and yet another activation function 363 may include both a heat propagation function and a humidity propagation function.

According to various embodiments, the digital twin 300 is an omnidirectional neural network. Typical neural networks are unidirectional—they include an input layer of neurons that activate one or more hidden layers of neurons, which then activate an output layer of neurons. In use, typical neural networks use a feed-forward algorithm where information only flows from input to output, and not in any other direction. Even in deep neural networks, where other paths including cycles may be used (as in a recurrent neural network), the paths through the neural network are defined and limited. The example digital twin 300, on the other hand, may include activation functions along both directions of each edge: the previously discussed “forward” activation functions 313, 325, 343, 345, 363, 365 (shown as solid arrows) as well as a set of “backward” activation functions 331, 334, 336, 352, 354, 356 (shown as dashed arrows).

In some embodiments, at least some of the backward activation functions 331, 334, 336, 352, 354, 356 may be defined in the same way as described for the forward activation functions 313, 325, 343, 345, 363, 365—based on domain knowledge. For example, while physics-based functions can be used to model heat transfer from a surface (e.g., a wall) to a fluid volume (e.g., an HVAC zone), similar physics-based functions may be used to model heat transfer from the fluid volume to the surface. In some embodiments, some or all of the backward activation functions 331, 334, 336, 352, 354, 356 are derived using automatic differentiation techniques. Specifically, according to some embodiments, reverse mode automatic differentiation is used to compute the partial derivative of a forward activation function 313, 325, 343, 345, 363, 365 in the reverse direction. This partial derivative may then be used to traverse the graph in the opposite direction of that forward activation function 313, 325, 343, 345, 363, 365. Thus, for example, while the forward activation function 313 may be defined based on domain knowledge and allow traversal (e.g., state propagation as part of a simulation) from node 310 to node 330 in linear space, the reverse activation function 331 may be defined as a partial derivative computed from that forward activation function 313 and may allow traversal from node 330 to 310 in the derivative space. In this manner, traversal from any one node to any other node is enabled—for example, the graph may be traversed (e.g. state may be propagated) from node 340 to node 310, first through a forward activation function 343, through node 330, then through a backward activation function 331. By forming the digital twin as an omnidirectional neural network, its utility is greatly expanded; rather than being tuned for one particular task, it can be traversed in any direction to simulate different system behaviors of interest and may be “asked” many different questions.

According to various embodiments, the digital twin is an ontologically labeled neural network. In typical neural networks, individual neurons do not represent anything in particular; they simply form the mathematical sequence of functions that will be used (after training) to answer a particular question. Further, while in deep neural networks, neurons are grouped together to provide higher functionality (e.g. recurrent neural networks and convolutional neural networks), these groupings do not represent anything other than the specific functions they perform; i.e., they remain simply a sequence of operations to be performed.

The example digital twin 300, on the other hand, may ascribe meaning to each of the nodes 310, 320, 330, 340, 350, 360 and edges therebetween by way of an ontology. For example, the ontology may define each of the concepts relevant to a particular system being modeled by the digital twin 300 such that each node or connection can be labeled according to its meaning, purpose, or role in the system. In some embodiments, the ontology may be specific to the application (e.g., including specific entries for each of the various HVAC equipment, sensors, and building structures to be modeled), while in others, the ontology may be generalized in some respects. For example, rather than defining specific equipment, the ontology may define generalized “actors” (e.g., the ontology may define producer, consumer, transformer, and other actors for ascribing to nodes) that operate on “quanta” (e.g., the ontology may define fluid, thermal, mechanical, and other quanta for propagation through the model) passing through the system. Additional aspects of the ontology may allow for definition of behaviors and properties for the actors and quanta that serve to account for the relevant specifics of the object or entity being modeled. For example, through the assignment of behaviors and properties, the functional difference between one “transport” actor and another “transport” actor can be captured.

The above techniques, alone or in combination, may enable a fully-featured and robust digital twin 300, suitable for many purposes including system simulation and control path finding. The digital twin 300 may be computable and trainable like a neural network, queryable like a database, introspectable like a semantic graph, and callable like an API.

As described above, the digital twin 300 may be traversed in any direction by application of activation functions along each edge. Thus, just like a typical feedforward neural network, information can be propagated from input node(s) to output node(s). The difference is that the input and output nodes may be specifically selected on the digital twin 300 based on the question being asked, and may differ from question to question. In some embodiments, the computation may occur iteratively over a sequence of timesteps to simulate over a period of time. For example, the digital twin 300 and activation functions may be set at a particular timestep (e.g., 1 minute), such that each propagation of state simulates the changes that occur over that period of time. Thus, to simulate longer period of time or point in time further in the future (e.g., one minute), the same computation may be performed until a number of timesteps equaling the period of time have been simulated (e.g., 60 one second time steps to simulate a full minute). The relevant state over time may be captured after each iteration to produce a value curve (e.g., the predicted temperature curve at node 310 over the course of an hour) or a single value may be read after the iteration is complete (e.g., the predicted temperature at node 310 after an hour has passed). The digital twin 300 may also be inferenceable by, for example, attaching additional nodes at particular locations such that they obtain information during computation that can then be read as output (or as an intermediate value as described below).

While the forward activation functions 313, 325, 343, 345, 363, 365 may be initially set based on domain knowledge, in some embodiments training data along with a training algorithm may be used to further tune the forward activation functions 313, 325, 343, 345, 363, 365 or the backward activation functions 331, 334, 336, 352, 354, 356 to better model the real world systems represented (e.g., to account for unanticipated deviations from the plans such as gaps in venting or variance in equipment efficiency) or adapt to changes in the real world system over time (e.g., to account for equipment degradation, replacement of equipment, remodeling, opening a window, etc.).

Training may occur before active deployment of the digital twin 300 (e.g., in a lab setting based on a generic training data set) or as a learning process when the digital twin 300 has been deployed for the system it will model. To create training data for active-deployment learning, the controller 210 may observe the data made available from the real-world system being modeled (e.g., as may be provided by a sensor system 140) and log this information as a ground truth for use in training examples. To train the digital twin 300, the controller 210 may use any of various optimization or supervised learning techniques, such as a gradient descent algorithm that tunes coefficients associated with the forward activation functions 313, 325, 343, 345, 363, 365 or the backward activation functions 331, 334, 336, 352, 354, 356. The training may occur from time to time, on a scheduled basis, after gathering of a set of new training data of a particular size, in response to determining that one or more nodes or the entire system is not performing adequately (e.g., an error associated with one or more nodes 310, 320, 330, 340, 350, 360 passed a threshold or passes that threshold for a particular duration of time), in response to manual request from a user, or based on any other trigger. In this way, the digital twin 300 may be adapted to better adapt its operation to the real world operation of the systems it models, both initially and over the lifetime of its deployment, by tacking itself to the observed operation of those systems.

The digital twin 300 may be introspectable. That is, the state, behaviors, and properties of the nodes 310, 320, 330, 340, 350, 360 may be read by another program or a user. This functionality is facilitated by association of each node 310, 320, 330, 340, 350, 360 to an aspect of the system being modeled. Unlike typical neural networks where, due to the fact that neurons don't represent anything particularly the internal values are largely meaningless (or perhaps exceedingly difficult or impossible to ascribe human meaning), the internal values of the nodes 310, 320, 330, 340, 350, 360 can easily be interpreted. If an internal “temperature” property is read from node 310, it can be interpreted as the anticipated temperature of the system aspect associated with that node 310.

Through attachment of a semantic ontology, as described above, the introspectability can be extended to make the digital twin 300 queryable. That is, ontology can be used as a query language usable to specify what information is desired to be read from the digital twin 300. For example, a query may be constructed to “read all temperatures from zones having a volume larger than 200 square feet and an occupancy of at least 1.” A process for querying the digital twin 300 may then be able to locate all nodes 310, 320, 330, 340, 350, 360 representing zones that have properties matching the volume and occupancy criteria, and then read out the temperature properties of each. The digital twin 300 may then additionally be callable like an API through such processes. With the ability to query and inference, canned transactions can be generated and made available to other processes that aren't designed to be familiar with the inner workings of the digital twin 300. For example, an “average zone temperature” API function could be defined and made available for other elements of the controller or even external devices to make use of. In some embodiments, further transformation of the data could be baked into such canned functions. For example, in some embodiments, the digital twin 300 itself may not itself keep track of a “comfort” value, which may defined using various approaches such as the Fanger thermal comfort model. Instead, e.g., a “zone comfort” API function may be defined that extracts the relevant properties (such as temperature and humidity) from a specified zone node, computes the comfort according to the desired equation, and provides the response to the calling process or entity.

It will be appreciated that the digital twin 300 is merely an example of a possible embodiment and that many variations may be employed. In some embodiments, the number and arrangements of the nodes 310, 320, 330, 340, 350, 360 and edges therebetween may be different, either based on the controller implementation or based on the system being modeled by each deployment of the controller. For example, a controller deployed in one building may have a digital twin 300 organized one way to reflect that building and its systems while a controller deployed in a different building may have a digital twin 300 organized in an entirely different way because the building and its systems are different from the first building and therefore dictate a different model. Further, various embodiments of the techniques described herein may use alternative types of digital twins. For example, in some embodiments, the digital twin 300 may not be organized as a neural network and may, instead, be arranged as another type of model for one or more components of the system 100. In some such embodiments, the digital twin 300 may be a database or other data structure that simply stores descriptions of the system aspects, environmental features, or devices being modeled, such that other software has access to data representative of the real world objects and entities, or their respective arrangements, as the software performs its functions.

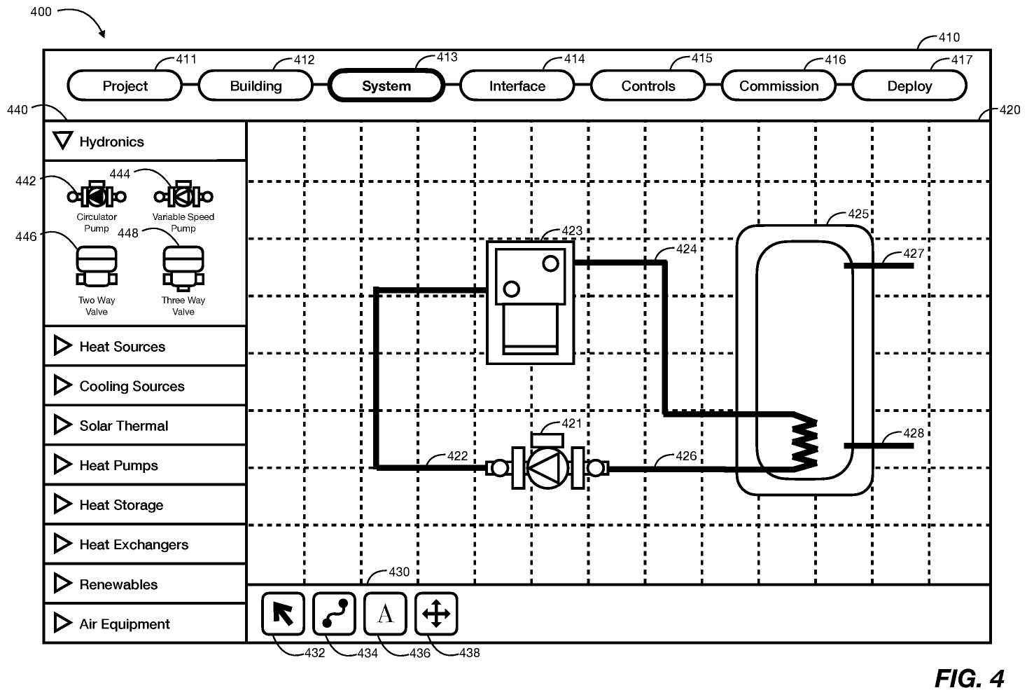

FIG. 4 illustrates an example graphical user interface 400 for enabling a user to define a digital twin. For example, the user interface 400 may be generated by or allow interaction with the digital twin creator 218 via the user interface 216 of the controller 210. The user interface 400 may facilitate creation of at least a part of the digital twin 220 such as the controlled system twin 224. In various alternative embodiments, the user interface 400 may not be provided by the controller 200 and, instead, may execute on another device such as a separate computer local to the user, a server, or hosted among multiple devices according to cloud computing principles. In some embodiments where the user interface 400 is provided by a device remote from the user, it may be presented as a software service and may be accessible, e.g., by the controller 210 or another user device via a web interface or over another networked channel. When the user interface 400 is hosted by a device other than the controller 210, the digital twin 220 (or portion thereof created using the user interface 400) may be provided to the controller 210 at a later time (e.g., after completion of the digital twin 220 or upon commissioning of the controller 210).

As shown, the user interface 400 may represent only one interface of a multi-interface software package. For example, the user interface 400 may be part of an overall project planning suite or digital twin definition suite. A navigation panel 410 includes a set of ordered indicators 411, 412, 413, 414, 415, 416 conveying an overall workflow for planning and executing an HVAC installation project: a Project indicator 411 associated with a basic information step for a project, a Building indicator 412 associated with defining the structure of the building (which may entail defining the environment twin 222) a System indicator 413 associated with defining the arrangement of the HVAC system (which may be accomplished via the presently shown interface 400), an Interface indicator 414 associated with defining a user interface, monitors, and controls that will be made available to occupants via the user interface 400 during deployment, a Controls indicator 415 associated with identifying the hardware and wiring requirements for installation of the project, a Commission indicator 416 associated with verifying the proper installation and functioning of the project, and a Deploy indicator 417 associated with setting the controller 210 into active operation. The System indicator 413 has an altered appearance compared to the other indicators 411, 412, 414, 415, 416, 417 (here, bold text and thick outer lines, but any alteration can be used) to indicate that it is the presently active step and associated with the presently-displayed interface 400. In some embodiments, visual or other cues can be used to indicate additional workflow information: that the steps associated with earlier indicators 411, 412 have been completed, that the current step is ready or not ready to be completed, that there is a problem with a step associated with an indicator 411, 412, 413, 414, 415, 416, 417, etc. In some embodiments, the indicators 411, 412, 413, 414, 415, 416, 417 may be interface buttons that enable, upon user click, tap, or other selection, the user to change the interface 400 to another interface associated with the selected indicator 411, 412, 413, 414, 415, 416, 417.

A workspace 420 includes an area where a user may graphically construct the controllable system (which the controller may then digest or otherwise use in creating the controlled system twin 224). A tool panel 430 may include a number of buttons 432, 434, 436, 438 that, when selected, provide respective tools for the user to interact with the workspace 420 or the avatars (graphical representations) 421-428 therein. For example, a cursor button 432 provides the user with a simple cursor for clicking and dragging the avatars 421-428 relative to the workspace 420 and each other; a connector button 434 provides the user with the ability to indicate a functional connection between certain avatars 421-428 (as will be explained in greater detail below); a text button 436 provides the user with the ability to annotate; and a pan button 438 allows the user to drag the view provided by the workspace 420 of the avatars 421-428 in any direction. Various additional tools may be provided without the use of buttons such as a zoom tool usable with a mouse scroll wheel or a pinch gesture. Various additional tools for interacting with a graphical design environment will be apparent.

The workspace 420 includes a number of system element avatars including a pump avatar 421, a boiler avatar 423, and a storage tank avatar 425. Additionally, a connection 422 extends between an output of the pump 421 to an input of the boiler 423; a connection 424 extends between an output of the boiler 423 to an input of the storage tank 425 (particularly, to an input of a heat exchanger of the storage tank 425); and a connection 426 extends between an output of the storage tank 425 to an input of the pump 421. The avatars 421-426 shown in the workspace 420 thus describe a real-world hydronic system where a pump moves fluid through a boiler to be heated and then through a heat exchanger of a storage tank to heat the water stored therein. This may be the complete system desired to be described for a project or digital twin creation (even though incomplete as to a real world installation) or the user may continue working using the interface 400 to add avatars of additional elements; remove, modify, or rearrange avatars of elements; or add, remove, or modify connections between the avatars.

To facilitate addition of avatars to the workspace 420, the interface 400 includes a library panel 440 including a list of available equipment avatars. As shown, the library panel 440 is grouped in several expandable categories, of which a “Hydronics” category is expanded to show four available avatars: a circulator pump 442, a variable speed pump 444, a two way valve 446, and a three way valve 448. It will be apparent that the contents of the library panel 440 may be a simplification and that additional or alternative categories or avatars may be available based on, for example, the application for which the interface is being used to design or the avatars that have been defined by the user or other party for use in the interface. In some embodiments, the library panel 440 may include many variations of the same equipment such as, for example, avatars for various manufacturers and models to account for differences therebetween. Various input may be used to indicate that a new avatars should be added to the workspace 420; in this example, a user may simply drag a desired avatars 442-448 from the library panel 440 and drop it at a desired location on the workspace 420. The user may then use that connector tool 434 to draw functional connections between the interfaces of the new avatars (not shown) and the interfaces of one or more other avatars. As shown, the storage tank avatars 427 includes two additional interfaces that are not connected to other avatars: an output 427 and an input 428 to the main reservoir of the storage tank avatars 425. To continue defining the system the user may, for example, drag the variable speed pump avatar 444 to the workspace 420 to create a new instance of a variable speed pump avatar (not shown), and then use the connector tool to create a connection from the output of the new variable speed pump avatar to the input 428 of the storage tank avatar 425. The user may then proceed in the same manner until the equipment system (or other system to be controlled) is fully or sufficiently defined.

While the various features of the interface 400 described may share features in common with various computer aided drafting or diagramming software (and may implement additional features from such other software), the interface 400 is useful to additionally generate a digital twin for use in controlling the real world system represented by the various avatars 421-426. To that end, each avatar 421-426, 442-448 carries with it or is otherwise linked to a digital twin that models at least a portion of the role, behavior, or properties of the real world equipment represented by that avatar 421-426, 442-448. These digital twins are composable in the sense that they may be connected or “clicked” together to form larger digital twins of greater complexity. Such composability may be enabled or facilitated by the inclusion of normalized interfaces in and out of the digital twins such that information can be passed between the digital twins for purposes of simulation, training, control path finding, or other applications. By providing normalized interfaces, input or output data from a digital twin conforms to particular expectations across the model (e.g., data types, required properties, constraints, or other expectations), providing a common “language” for communication and interoperation. Thus, when it is time for the controller 210 or other device to generate the data arrangement that will define the digital twin (e.g., on the fly in response to each change or after the user is finished), digital twins for a pump, boiler, and storage tank may be connected to form a digital twin of the full hydronic loop shown.

In the other direction, the digital twins for each of the equipment may themselves be composed of multiple simpler digital twins connected via normalized interfaces. A digital twin may be reduced down to its elementary “components,” which may represented in the data arrangement as a single node with various behaviors, properties, a role, or other features. As such, the equipment digital twins associated with the equipment avatars 421, 423, 425 may be represented as a set of nodes, already interconnected so as to model the functioning of their corresponding equipment.

In some embodiments, in addition to the device avatars 421, 423, 435, the connections 422, 424, 426 may also be avatars that represent the physical connections between the real world devices and are associated with digital twins to model the paths (e.g., in the case of the hydronic system shown, to model the pipes connecting the pump, boiler, and storage tank). As such, rather than, e.g., the output interface of the pump avatar's 421 digital twin connecting directly to the input interface of the boiler avatar's 423 digital twin, it may instead connect to the input interface of the connection avatar's 422 digital twin (whose output interface then connects to the input interface of the boiler avatar's 423 digital twin). The separate definition of digital twin for paths may introduce additional granularity to the digital twin and allow for features such as learning the flow rate through pipes or detecting problems such as reduced flow or leaks. In other embodiments, some or all “path” digital twins may be omitted and equipment digital twins may connect directly to one another.

In some embodiments, the interface 400 may check for completeness or other system criteria. Various approaches may be employed for such a check such as determining whether any interfaces are unconnected in the graphical representation (such as the unconnected interfaces 427, 428 of the storage tank avatar 425) or analyzing the digital twin “underneath” the visualization to determine whether it is complete or sufficiently operable. In some embodiments, the interface 400 may indicate when the system criteria are met so that the user can choose to move on. For example, the System indicator 413 may change appearance between an incomplete and a sufficiently complete system. In some embodiments, the interface 400 may only allow the user to proceed in the workflow when the system criteria are met. Where the indicators 411-417 are navigation buttons, the next Interface indicator 414 may not become active or selectable until the system criteria are met.

Having described an example avatar-based graphical description 421-428 of a real world system, an example of an associated digital twin according to the foregoing principles will now be described, first with respect to a twin of an individual piece of equipment—storage tank's 425 twin- and then with respect to the higher order system.

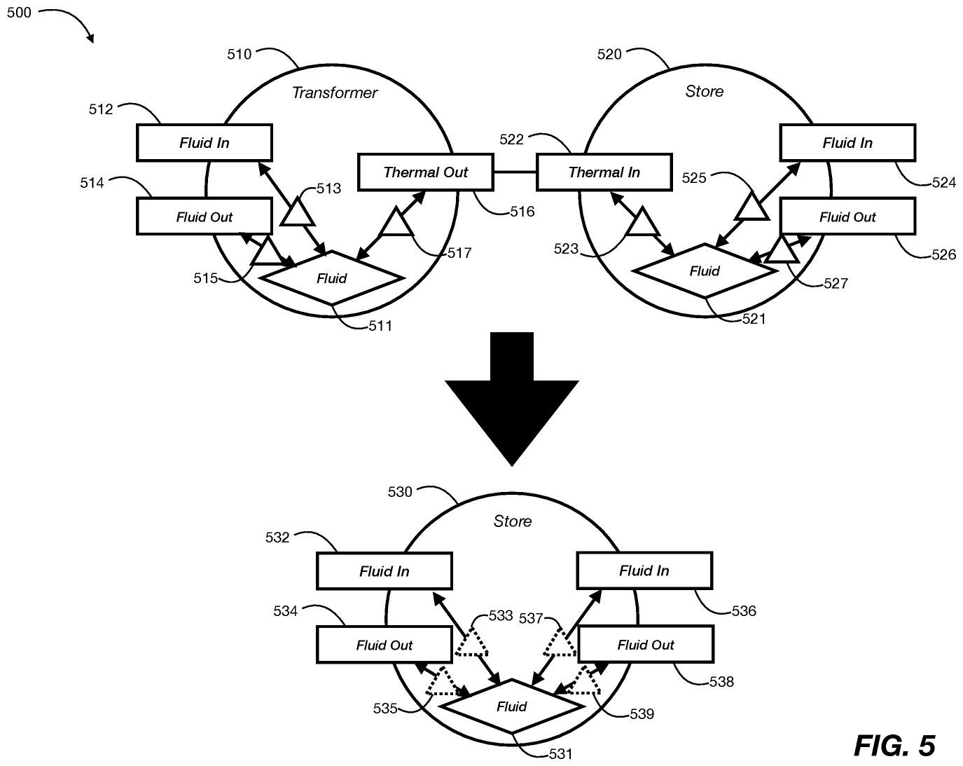

FIG. 5 illustrates an example of a digital twin 500 for modeling a storage tank according to two levels of detail. The digital twin 500 may, for example, correspond to the storage tank avatar 425 from the interface 400 and, as such, may also correspond to a real world storage tank having one heat transfer coil (having an input and an output) and a fluid reservoir (having an input and an output). While the digital twin 500 is illustrated alternatively as a two-node graph and as a single node, it will be apparent that various approaches to data organization may be employed to capture the information and relationships illustrated.

According to a first, lower level of detail, the digital twin 500 includes a first node 510 connected to a second node 520. These nodes 510, 520 are ontologically labeled according to their role in the system and, as such, have “actor” types. The data type that each node 510, 520 operates on is also labeled to the respective node 510, 520 as a “quanta” type. Each actor and quanta combination may be associated with a set of default behaviors and properties that describe how to model its corresponding real world device or system aspect, but in some embodiments, these devices and behaviors may be changed by, for example, selection of an avatar in the interface 400 (or another digital twin composition interface) with a pre-customized set of behavior and properties, manual configuration by a user, through pre-deployment training, or through deployment phase learning.

The first node 510 is a “transformer” actor type whose primary role is to transform one type of quanta to another. The transformer node 510 has an internal quanta type 511 of “fluid” and receives fluid as input, but outputs a thermal quanta as a function of the transformation. The transformer node 510 also outputs fluid quanta after the transformation has occurred. The transformer node 510 may correspond to the heat transfer coil of the real world storage tank represented by the storage tank avatar 425.

The second node 520, on the other hand, is a “store” actor type whose primary role is to store quanta. The store node 520 has an internal quanta type 521 of “fluid,” receives fluid as input, and may provide fluid as output. The store node 520 may also include a property (not shown) that keeps track of the fluid currently simulated as stored in the store node 520. While the primary function of the store actor is to store quanta, it may be arranged to exhibit additional behaviors as secondary roles. This store node 520 also accepts thermal quanta in and uses it to simulate temperature changes to its stored fluid quanta. The store node 520 may correspond to the internal reservoir of the real world storage tank represented by the storage tank avatar 425.

When connected, the two nodes 510, 520 may operate together to simulate the full operation of that real world storage tank and, as such, may be alternative represented as a single node 530 representing the entire piece of equipment. Such a higher level view may be taken by applications and at levels of detail that do not have a need or interest to view the inner workings of that particular piece of equipment and, in the case of the storage tank, are interested in the tanks ability to be connected to a hot and cold water supply, rather than the operation of the heat transfer coil. At this level, the neuron 530 takes and actor and quanta type (“store” and “fluid”) inferred from the lower level representation of the neurons 510, 520. Because the primary role of the storage tank at this level is still to store fluid quanta, the “store” actor type and “fluid” quanta type are inherited from the store node 520. Various approaches for inferring actors and quanta types for higher level nodes may be used such as, for example, employing a set of rules or heuristics for making the decision, referring to a lookup table with correspondences between groups of nodes to the inferred actor and quanta types, or using a machine learning model or other artificial intelligence reasoning approach to assign the actor and quanta types.

Returning to the transformer node 510, in addition to the specification of fluid quanta 511, it includes three normalized interfaces: a fluid in interface 512, a fluid out interface 514, and a thermal out interface 516. Each of these interfaces 512, 514, 516 may be connected to matching normalized interfaces of other nodes the connection may be operable—e.g., a simulation may be computed across the connection. In various embodiments, normalized interfaces may match when they form an input and output pair and when they are associated with the same or sufficiently similar data types (e.g., the same quanta type; having the same or similar properties; or having the same, similar, or otherwise compatible constraints.)

Internally, when the node 510 receives quanta at one of its input interfaces, it may apply one or more activation functions 513, 515, 517 to determine how to update its own properties or what quanta to output to its output interfaces. For example, when the node receives fluid quanta at its fluid in interface 512, it may apply a first activation function 513 to determine how much fluid will enter the node 510 during a simulation timestep. Such activation function 513 may be a physics-based behavior, taking into account the pressure of the input fluid (e.g., as may be carried by the received quanta) and internal properties of the transformer node 510 such as physical dimensions of the modeled heat exchange coil. Next, the transformer node 510 may apply a second activation function 517 that, based on a thermal energy property of the received fluid quanta, extracts thermal quanta to output via the thermal out interface 516 and modifies the thermal energy property of the fluid. Again, such behavior may be defined based on physics-based equations modeling such thermal energy transfers. Finally, the transformer node 510 may apply a third activation function 515 to the fluid quanta to model how much fluid will be pushed out to the next node (not shown or not yet connected in FIG. 5).

It will be apparent that various modifications to the node 510 (and other nodes 520, 530) are possible while implementing the same or similar behavior. For example, the node 510 may include additional interfaces or additional activation functions, or one or more of the activation functions 513, 515, 517 may be combined into a single function.

The store node 520 may include three interfaces as well—a thermal in interface 522, a fluid in interface 524, and a fluid out interface 526. During a timestep of a simulation, the store node 520 receives two types of quanta—thermal quanta at the thermal in interface 522 and fluid quanta at the fluid in interface 524. A first activation function 523 applies the thermal quanta to the fluid quanta stored in the store node 520 (e.g., raising a temperature property of the stored fluid quanta). Meanwhile, the store node 520 receives fluid quanta at the fluid in interface 524, and a second activation function 525 determines how much (e.g., based current fill level and capacity properties and pressure of the incoming quanta) fluid will be added to its current internal fluid storage. The store node 520 then applies a third activation function 527 to determine how much (and what other properties of) quanta will be output through the fluid out interface 526.

By connecting the thermal out interface 516 to the thermal in interface 522, the transformer node 510 and store node 520 may cooperate to model the full function of the storage tank represented by the storage tank avatar 425. That is, thermal energy may be extracted from heated fluid quanta provided at the fluid in interface 512 of the transformer node 510 (representing the heat exchange coil) and applied via the two thermal interfaces 516, 522 to the fluid received and held within the store node 520 via the fluid in interface 524. In this regard, the two nodes 510, 520 may be viewed as a single node 530 combining their functions and hiding those operations that are now purely internal to the arrangement of nodes 510, 520—namely the heat transfer. As such, the combined store node 530 may be seen as having a fluid internal quanta 531, a first set of fluid in 532 and fluid out 534 interfaces (inherited from the transformer node 510 and, thus, representing the input and output of the heat exchange coil), and a second set of fluid in 536 and fluid out 538 interfaces (inherited from the store node 520 and thus representing the input and output of the storage reservoir).

The activation functions 533, 535, 537, 539 may similarly operate on the quanta internal to the node 530. These activation functions 533, 535, 537, 539 are shown in dotted line to indicate that they may simply represent the same activation functions 513, 515, 517, 523, 525, 527 previously described. In other words, the combined store node 530 may not actually replace the two nodes 510, 520 but merely be an abstracted representation for purposes of, for example, visualization on a user interface. The storage tank avatar 425, for example, may in a sense be a graphic visualization of the combined store node 520, as it shows a single avatar with two inputs and two outputs. Thus, for example, the activation function 533 may be a “virtual” activation function representing the operations of the activation functions 513, 517, 523 that are responsible for simulating receiving hot fluid and using it to heat the stored fluid. In other embodiments, the combined store node 530 may in fact replace the two nodes 510, 520. The controller 210 or other device may compile or otherwise combine the data structures and activation functions such that, for example, a new activation function 533 combines and replaces activation functions 513, 517, 523, and the thermal interfaces 516, 522 are removed entirely. Various combinations of these two approaches may be used for balancing granularity and efficiency of simulations.

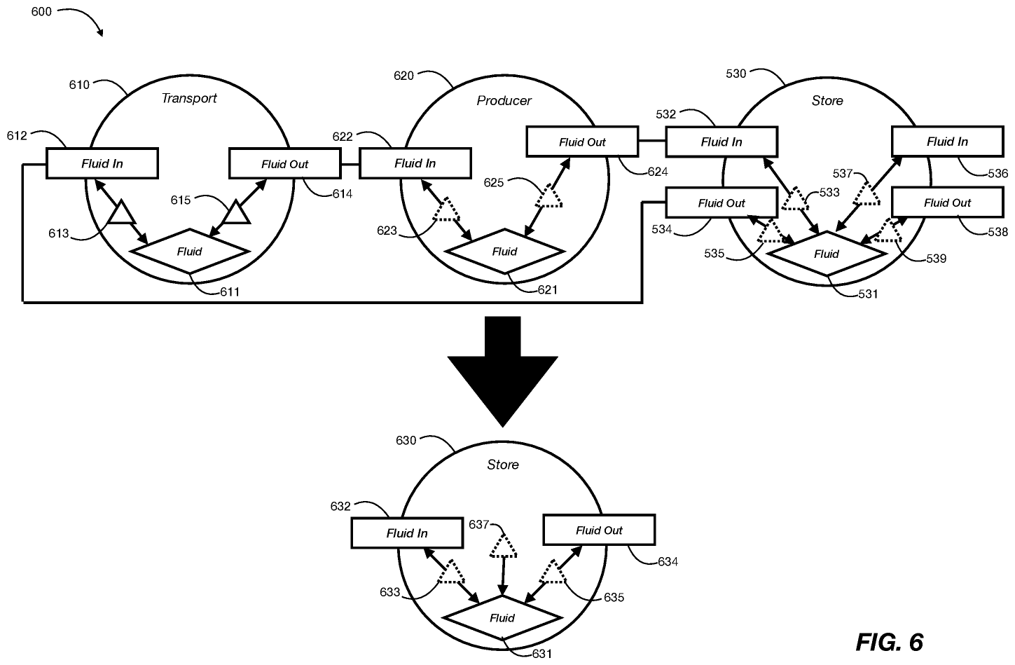

FIG. 6 illustrates an example of a digital twin 600 for modeling a hydronic system according to two levels of detail. For example, the digital twin 600 may model the hydronic system of a pump, boiler, and storage tank as illustrated in the interface 400 of FIG. 4. The digital twin 600 thus includes a transport node 610 (to model the pump represented by the pump avatar 421), a producer node 620 (to model the boiler represented by the boiler avatar 423), and the store node 530 described in connection with FIG. 5 (to model the storage tank represented by the storage tank avatar 425). All three nodes 610, 620, 530 may have fluid internal quanta 611, 621, 531. These nodes may cooperate together to heat fluid stored in a storage tank and, as such, may be viewed as a single store node 630 having a fluid internal quanta 631 (in a manner similar to that previously described) that represents the full subsystem as a storage tank that stores heated fluid.

The transport node 610 includes a fluid input interface 612 that receives fluid quanta, applies a first transfer function 613 to determine how much fluid quanta will enter the modeled pump during a timestep, a second transfer function 615 to determine how much fluid will exit the pump during the timestep (and at what pressure), and a fluid output interface 614 for passing the modified quanta to the next node (in this example, the producer node 620). As shown, the activation functions 613, 615 may represent real (nonvirtual) activation functions and, as such, the transport node 610 may be the lowest level of abstraction for actor nodes, i.e., a component node. In various embodiments, the activation functions 613, 615 may be modeled by a single “flow through” activation function, as will be described in greater detail below.

The producer node 620 includes a fluid input interface 622 that receives fluid quanta (as shown, from the transport node 610), a first activation function 623 to determine how much fluid quanta will enter the modeled boiler during the timestep, a second activation function 625 to determine how much fluid quanta will exit the modeled boiler during the timestep and at what temperature, and a fluid output interface 624 for passing the quanta to the next node (in this example, the store node 530). As illustrated, the operations of some nodes may impact the operation (e.g., application of activation functions) of other nodes. For example, the transport node 610 may increase a pressure property of fluid quanta passed to the producer node 620, which may then use this pressure property to determine how quickly fluid quanta will flow through the producer (i.e., how much fluid quanta will enter and exit during a timestep). This arrangement thus models the downstream effect the real world pump will have on the hydronic system. The activation functions 623, 625 are shown as virtual activation functions. Thus, the producer node 620 may actually represent multiple combined nodes (not shown) composing a more granular digital twin for the boiler, in a manner similar to that described for the store node 530 with respect to FIG. 5.

The store node 530 may complete a full loop of the hydronic system by receiving fluid quanta at its first fluid in interface 532, using its thermal energy property to heat the fluid it stores, and then passing the fluid quanta back to the fluid in interface of the transport node 610. This subsystem digital twin may then be combined with other subsystem (or equipment, component, or other level of abstraction) digital twins by, for example, attachment to the second fluid input 536 and fluid output 538 interfaces.

As previously-described, in some embodiments, the pipes connecting the three pieces of equipment may themselves be modeled as separate “Path” nodes (not shown). Such an approach may be taken when modeling or learning the behaviors of such pipes is desired. For example, the system designer may wish to take into account the natural resistance each pipe poses to the pressure of the system between the more complex equipment devices, or to better detect and locate faults in the system such as leaky pipes (e.g., as the learning process responsible for keeping the twin 600 consistent with the observations of the real world system learns that the system is not behaving as expected, it may identify a pipe node in particular as losing an amount of pressure or quanta volume consistent with a leak).

Taking a higher level view, the nodes 610, 620, 530 may be represented by a single store node 630, having an internal quanta of fluid 631, a fluid in interface 632 (which corresponds to the second fluid in interface 536 of store node 530), and a fluid out interface 634 (which corresponds to the second fluid in interface 538 of store node 530). A first virtual activation function 633 may determine how much fluid quanta is taken into the store node 630 during a timestep (corresponding to filling the reservoir). As such, this virtual activation function 633 may correspond to the similar activation function 537 of store node 530. In a similar manner, a second virtual activation function 635 may determine how much fluid quanta is output from the store node 630 in a time step (corresponding to supplying fluid from the storage tank's reservoir) and, as such, may correspond to the similar activation function 539 of the store node 530. The store node 630 may include an additional virtual activation function 637 that, at this level of abstraction, can be seen as purely internal to the store node 630. This activation function 637 may correspond to the activation functions 613, 615, 623, 625, 533, 635 of the lower level nodes 610, 620, 530, and as such may model the temperature change to the stored fluid in a single timestep.

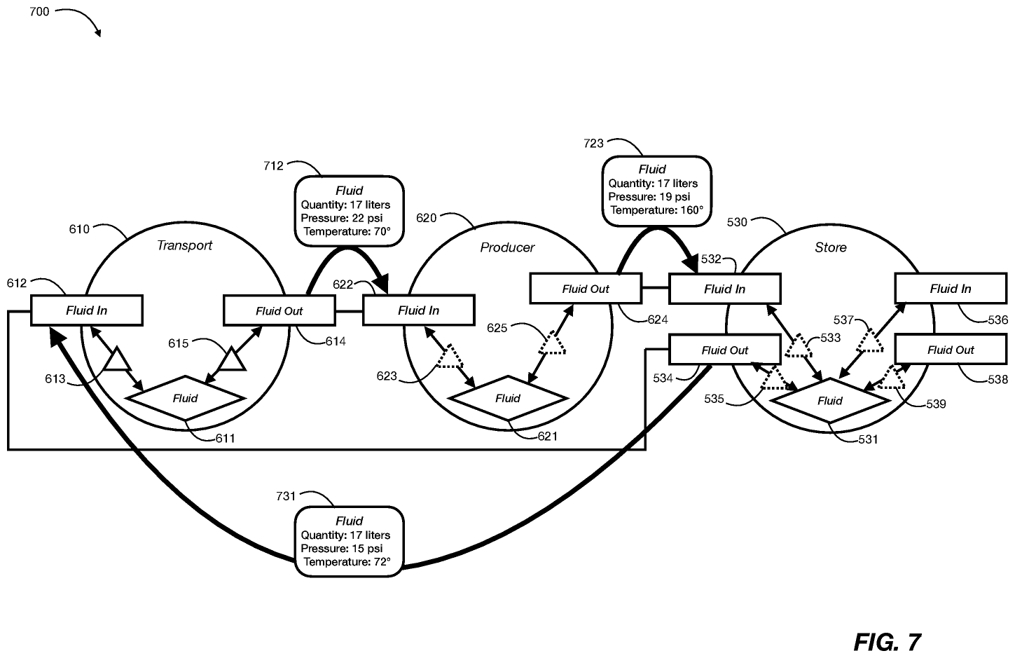

Having described an example organization of a subsystem digital twin, an example of simulation of subsystem operation will now be described. FIG. 7 illustrates an example simulation 700 of a subsystem digital twin. The simulation 700 may be performed against the nodes 610, 620, 530 of the digital twin 600 and, as such, may simulate the operation of a hydronic subsystem as graphically depicted in interface 400.

To begin a simulation, the controller 210 may first identify a starting node for computation. In various embodiments, the order of simulation may not have a bearing on the outcome, but the iterative process nonetheless chooses a node at which to start. For example, the controller may begin a timestep with transport node 610 and determine (e.g., based on application of transfer function 615) that particular quanta will be output through the fluid out interface. In various embodiments, quanta may be passed between nodes in the form of a discreate packet or other data object describing the quanta. For example, as shown, the transport node 610 has output a quanta object of type fluid with three properties: a quantity (17 liters), a pressure (22 psi) and a temperature (70°). In some embodiments, regardless of how much or how little quanta is output, it may be expressed by a single quanta object that expresses the volume, amount, or other quantity measure of quanta being passed. In other embodiments, the quantity may be expressed by a corresponding number of quanta objects being passed between nodes (e.g., instead of a single fluid object for 17 liters, 17 quanta objects for each liter).

After simulating the transport node 610, the controller 210 may move through the path matching the flow of quanta and begin to compute the producer node 620. As previously described, the producer node 620 may actually be two or more nodes (not shown) that operate together to implement the simulated role, behavior, and properties of the abstracted producer node 620; in such case, the controller 210 may proceed to simulate such lower-level nodes in an appropriate order. For the purposes of the present example, producer node 620 will described as a component level node. The activation function 623 may read fluid quanta from the fluid input interface and determine how much will be brought into the producer node 620 or even passed fully through the producer node in the current timestep.

In various embodiments, the fluid quanta 712 output by the transport node 610 may not yet be available to the producer node 620; instead, the producer node 620 may have access to the fluid quanta (not shown) output by the transport node on the previous timestep simulation. This follows from the notion that in such embodiments, each node 610, 620, 530 is responsible for simulating how much quanta it moves (and how much it modifies the quanta) during the course of a single timestep. Thus, to make the same fluid quanta 712 immediately available to the producer node 620 in the same timestep simulation would be to jump ahead in the simulation. For the sake of simplifying the present explanation, however, each node 610, 620, 530 will hereafter be described as operating on the same or identical quanta objects as those output by the preceding node 610, 620, 530. Such a situation may be encountered where the system is simulated as in a stable state—on each timestep, each node outputs the same quanta with the same properties as the last timestep. Quanta properties may change from timestep to timestep, on the other hand, where the system has not reached a stable state—e.g., the system is warming up, in the midst of deactivation, experiencing a new fault, or under the effects of a new external stimulus.

Moving on with the example of a stable state system operation, the producer node 620 reads the (previous-timestep) quanta object 712, drops the pressure from 22 to 19 psi (based on the producer node's 620 internal resistance) and increases the temperature from 70° to 160° (based on the producer's internal behavior of imparting thermal energy to fluid quanta). The producer node 620 then outputs its quanta object with these properties to its fluid output interface 624.

Next, the store node 530 reads the (previous-timestep) quanta object 723 at its fluid input interface 532, drops the pressure from 19 to 15 psi (based on the store node's 530 internal resistance), drops the temperature from 160° to 72°, increases the temperature of its internally-stored fluid (or maintains it against natural temperature drop due to the effects of the relatively cooler environment). The store node 530 then outputs the fluid quanta object with the new properties through the fluid output interface 534, back to the transport node 610 to complete the loop and to be processed on the next timestep simulation. The controller 210 may iterate in this fashion for a number of timesteps, to simulate the desired amount of time.

Depending on the particular simulation, the controller 210 may read one or more properties of the nodes or quanta objects to produce the output of the simulation. For example, where the simulation is performed to simulate the temperature of the fluid stored in the water tank over the following two hours under a particular set of controls, the controller 210 may iterate for 120 timesteps as previously described and, after each timestep, read the internal temperature property of the store node 530 and record it as part of a time series of values. Having created such a time series curve, the controller 510 may then determine if further action is necessary—for example, if the simulated temperature drops below a desired value, the controller 510 may attempt to decide how to control the pump or boiler to bring the simulated time series back to the desired range. To do so, the controller 210 may generate a candidate control scheme (e.g., randomly or based on heuristic rules) and simulate the system again to determine if it improves the outcome. As another possibility, the controller 210 may generate a cost function from the digital twin 600 with independent variables of the available control actions and dependent variable tracking the error of the simulated time series curve (or point value) from the desired curve (or point value). Then, applying gradient descent or other optimization methods to the cost function, the controller 210 may identify a set of control actions predicted to optimize or improve the simulated temperature of the fluid in the storage tank.

According to the foregoing, various principles and techniques provide for improvements to the technical field of digital twin. For example, by providing a neuron-based digital twin with normalized interfaces, new digital twin may be composed by connecting neurons of other previously-built digital twins at their matching interfaces, thereby providing a high degree of reusability. Such digital twins may offer numerous additional technical benefits such as the ability to run simulations, locate ideal control paths for controlling a real system, tracking the operation of the system to identify faults or increase efficiency, or identifying hidden variables of the system such as device health or lifetime. Numerous additional technical benefits will be apparent in view of the present disclosure.

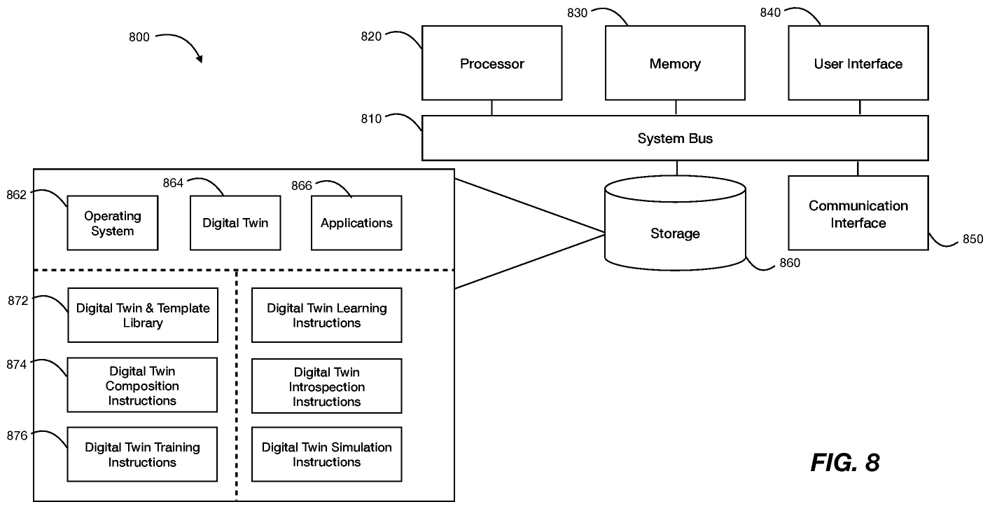

FIG. 8 illustrates an example hardware device 800 for implementing a controller, server, or other device for defining or utilizing a digital twin. The hardware device 800 may describe the hardware architecture and some stored software of one or more of the controllers 132-138, 210 previously described or may describe the hardware of another device implementing some or all of the functionality described herein such as, for example, enabling design of a digital twin before any controller has been installed. As shown, the device 800 includes a processor 820, memory 830, user interface 840, communication interface 850, and storage 860 interconnected via one or more system buses 810. It will be understood that FIG. 8 constitutes, in some respects, an abstraction and that the actual organization of the components of the device 800 may be more complex than illustrated.

The processor 820 may be any hardware device capable of executing instructions stored in memory 830 or storage 860 or otherwise processing data. As such, the processor 820 may include a microprocessor, field programmable gate array (FPGA), application-specific integrated circuit (ASIC), or other similar devices.

The memory 830 may include various memories such as, for example L1, L2, or L3 cache or system memory. As such, the memory 830 may include static random access memory (SRAM), dynamic RAM (DRAM), flash memory, read only memory (ROM), or other similar memory devices. It will be apparent that, in embodiments where the processor includes one or more ASICs (or other processing devices) that implement one or more of the functions described herein in hardware, the software described as corresponding to such functionality in other embodiments may be omitted.

The user interface 840 may include one or more devices for enabling communication with a user such as an administrator. For example, the user interface 840 may include a display, a mouse, a keyboard for receiving user commands, or a touchscreen. In some embodiments, the user interface 840 may include a command line interface or graphical user interface that may be presented to a remote terminal via the communication interface 850 (e.g., as a website served via a web server).

The communication interface 850 may include one or more devices for enabling communication with other hardware devices. For example, the communication interface 850 may include a network interface card (NIC) configured to communicate according to the Ethernet protocol. Additionally, the communication interface 850 may implement a TCP/IP stack for communication according to the TCP/IP protocols. In devices 800 that operate as a device controller, the communications interface 850 may additionally include one or more direct wired connections to such controlled devices or connections to separate I/O modules (not shown) providing such connections. In applications where the device 800 is deployed in the context of an HVAC system, the communications interface may communicate according to an appropriate protocol such as BACnet. Various alternative or additional hardware or configurations for the communication interface 850 will be apparent.

The storage 860 may include one or more machine-readable storage media such as read-only memory (ROM), random-access memory (RAM), magnetic disk storage media, optical storage media, flash-memory devices, or similar storage media. In various embodiments, the storage 860 may store instructions for execution by the processor 820 or data upon with the processor 820 may operate. For example, the storage 860 may store a base operating system 862 for controlling various basic operations of the hardware 800.

The storage 860 additionally includes a digital twin 864, such as a digital twin according to any of the embodiments described herein. As such, in various embodiments, the digital twin 864 includes a heterogeneous and omnidirectional neural network. The storage also includes one or more applications 866 that may make use of the digital twin 864. For example, the applications 866 may include an application for controlling a system of HVAC equipment, an application for providing a user interface of current and predicted state, an application for allowing a user to run simulations against one or more hypotheses, an application for assisting product design with simulation and other digital twin-derived insights, or any other application that may make use of a digital twin 864. Thus, in some embodiments, the applications 866 may correspond to one or more components of the controller 210 such as the solver engine 250 or semantic translator 232. In some embodiments, some or all of the applications 866 may not be coresident in the storage 860 with the digital twin 864 and, instead, may be run on other systems that access the digital twin 864 as needed with remote calls, e.g., via the communications interface 850 and an application programmer interface (API) (not shown).

In embodiments where the hardware device 800 enables initial creation of a digital twin, the storage 860 may store software for facilitating such function: a digital twin & template library 872, digital twin composition instructions 874, and digital twin training instructions 876. The digital twin & template library 872 may store the building blocks from which the digital twin 864 may be constructed or modified. As previously noted, at some levels, the digital twin 864 is composed from the combination of smaller digital twins and, as such, the digital twin & template library 872 may store additional digital twins that may be incorporated into the larger digital twin 864. Put another way, where the digital twin 864 is to be defined at the full system level, the digital twin & template library 872 may store previously-created component digital twins, equipment digital twins (formed from component digital twins), or sub-system digital twins (formed from equipment digital twins). Where new component digital twins may be defined for creation of the digital twin 864, the digital twin & template library 872 may also store templates from which new components may be defined and then made available in the library 872 as new component digital twins.

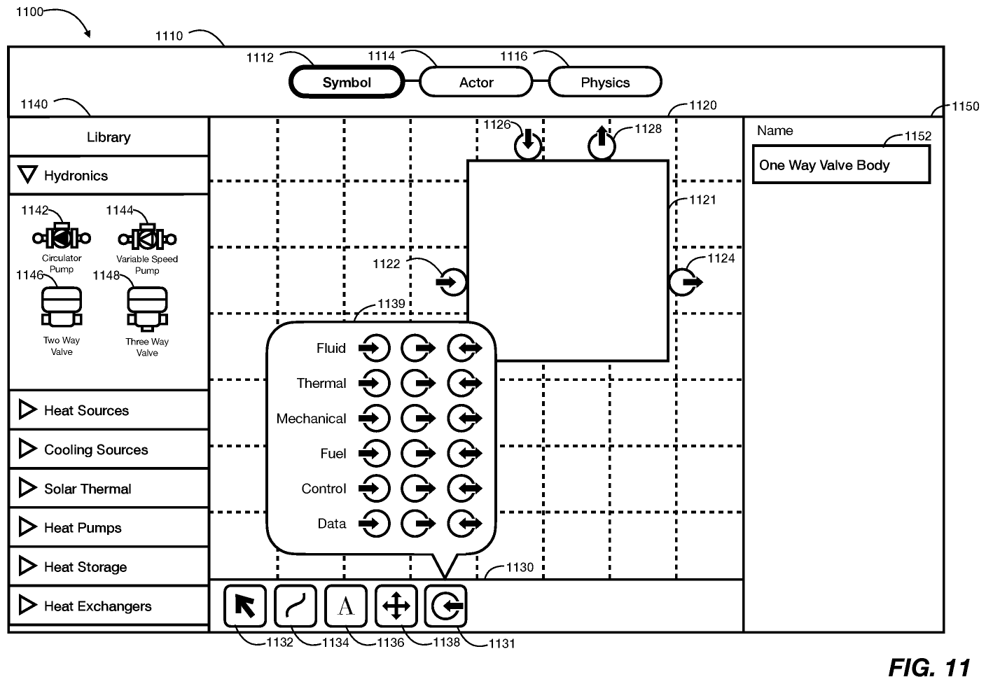

Digital twin composition instructions 874 may include instructions for combining smaller digital twins together to compose the digital twin 864. To accomplish such composition, the digital twin composition instructions 874 may, based on a determination that two digital twins (e.g. from the library 872) should be connected at particular interfaces, store such digital twins (or pointers thereto) along with an indication of the connection in the data arrangement defining the digital twin 864. In some embodiments, such determinations may be made automatically by software and, in some embodiments, a user may be able to indicate which digital twins should be used and how they should be connected. As such, in some embodiments, the digital twin composition instructions 874 may provide one or more user interfaces (to be served via the user interface 840 or the communications interface 850) for enabling a user to graphically compose a digital twin, which the digital twin composition instructions 874 may then translate into a data structure for storage as, or inclusion in, the digital twin 864 (where the full system is being defined) or the digital twin & template library 872 (where a lower level digital twin is being defined for later use). Thus, the digital twin composition instructions may correspond to the digital twin creator 218, may present an interface such as interface 400 for building the digital twin 864, or may present another interface (such as those described in connection with FIGS. 11-16) for defining digital twins.

Digital twin training instructions 876 may, after the digital twin 864 has been composed, employ one or more training methods to better adapt the textbook activation functions of the digital twin to real world conditions. For example, the digital twin training instructions 876 may execute a gradient descent or other learning algorithm to tune the parameters of the digital twin 864 before deployment. Such training may utilize training data gathered from the specific real world system being modeled or from a system that is sufficiently similar to the real world system being modeled.

Where the device 800 is intended to use the digital twin 864 for a runtime application 866 (such as autonomous building control), the storage 860 may include software for facilitating such activity. As shown, for example, the storage 860 may include digital twin learning instructions 882, digital twin introspection instructions 884, and digital twin simulation instructions 886. The digital twin learning instructions 882 may, during runtime, further train the digital twin 864 based on run-time observations from the real-world system it models. As such, in some embodiments, the digital twin learning instructions 882 may be similar to, identical to, or even leverage at least some of the same instructions as the digital twin training instructions 876. The digital twin learning instructions 882 may correspond, for example, to the learning engine 268 step engine of the controller 210. By tracking the operation of the real world system(s), the digital twin learning instructions 882 may not only account for deviations between the system's ideal design and real world implementation at the beginning, but also later-arising deviations such as system faults, modifications, or other changes.

The digital twin introspection instructions 884 may enable other components (e.g., the applications 866 or digital twin simulation instructions 886) to read data from the digital twin 864 and, as such, may correspond to at least some of the functionality of the inference kit 266. For example, where a simulation is interested in the temperature of a storage tank after simulation, the digital twin introspection instructions 884 may be configured to locate the node of the digital twin 864 representing that storage tank, locate the property of that node representing the internal temperature, read the property out, perform a transform (e.g., from internal units to units understood by the requestor), and serve the data back to the requestor. In some embodiments, the digital twin introspection instructions may also implement a query language based on the ontology with which the digital twin 864 is labeled, such that complex requests can be served (e.g., “read out the value curves of humidity in any interior wall between an hour ago and an hour from now”).

The digital twin simulation instructions 886 may perform requested simulations against the digital twin 864 and, as such, may correspond to the simulator step engine 262. To perform a such a simulation, the digital twin simulation instructions 886 may determine one or more output nodes of the digital twin 864 that will provide the requested simulated data, iterate through multiple timesteps of propagating quanta through the digital twin 864 toward the output node(s), read the data from the output nodes (e.g., making use of the digital twin introspection instructions 884), and finally package and serve the result back to the requestor. In various embodiments, such simulation may be performed by making a copy of or otherwise instantiating the digital twin 864 in storage 860 or memory 830 such that it can be modified for the purposes of simulation, while preserving the current definition and state of the digital twin 864. In such embodiments, the digital twin simulation instructions 886 may be responsible for such instantiation, perform the simulation against the instantiated digital twin 864, and release the storage or memory space for the instantiated digital twin 864 after simulation is complete. In some embodiments, rather than freeing up the storage or memory space, the digital twin simulation instructions 886 may leave the instantiated digital twin 864 in place for other functions (e.g., as may be called for in later steps of a recipe 252) may use the instantiated digital twin 864 after the simulation has been performed.

While not shown, the storage may include additional instructions, such as instructions for implementing on or more of the functions described in connection with the controller 210 of FIG. 2. It will also be apparent that various information described as stored in the storage 860 may be additionally or alternatively stored in the memory 830. In this respect, the memory 830 may also be considered to constitute a “storage device” and the storage 860 may be considered a “memory.” Various other arrangements will be apparent. Further, the memory 830 and storage 860 may both be considered to be “non-transitory machine-readable media.” As used herein, the term “non-transitory” will be understood to exclude transitory signals but to include all forms of storage, including both volatile and non-volatile memories.

While the hardware device 800 is shown as including one of each described component, the various components may be duplicated in various embodiments. For example, the processor 820 may include multiple microprocessors that are configured to independently execute the methods described herein or are configured to perform steps or subroutines of the methods described herein such that the multiple processors cooperate to achieve the functionality described herein, such as in the case where the device 800 participates in a distributed processing architecture with other devices which may be similar to device 800. Further, where the device 800 is implemented in a cloud computing system, the various hardware components may belong to separate physical systems. For example, the processor 820 may include a first processor in a first server and a second processor in a second server.

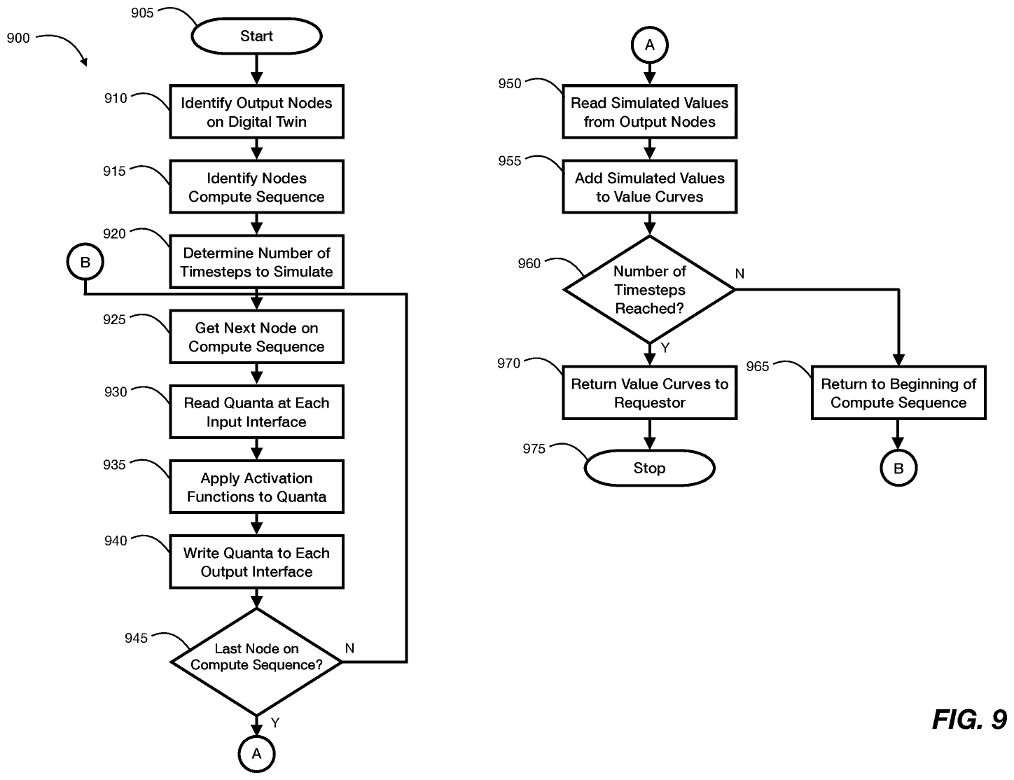

FIG. 9 illustrates an example method 900 for performing a simulation against a digital twin. As such, the method 900 may correspond to the simulator 262 step engine or the digital twin simulation instructions 886. The method begins in step 905 where a request for performing a simulation initiates the method 900. For example, a recipe 252 may indicate that a simulation is to be performed, and the solver engine 250 may instruct the simulator 262 to perform the simulation, including one or more parameters for the simulation (e.g., desired value(s) to be simulated and an amount of time to be simulated).

The method 900 proceeds to step 910 where the simulator identifies one or more output nodes from which the desired simulated date will be made available. Such an identification may be specified or otherwise determined from the request for the simulation. For example, if the request indicates a desire to know the temperature of a storage tank, the simulator may, in step 910, identify the node of the digital twin associated with the storage tank.

In step 915, the simulator identifies a compute sequence for the nodes. In some embodiments, the order of computation may have an effect on the operation of the simulation. In some such embodiments, the simulator may identify the propagation paths through the digital twin such as, for example, the propagation paths from each node to the output node(s) identified in step 910. In some embodiments, the order of computation may not have much or any bearing on the operation of the simulation. In some such embodiments, step 915 may entail simply obtaining an arbitrary ordering of nodes such as, for example, the order in which they are stored in memory. In some embodiments, the full digital twin may not need to be computed to provide the requested simulation; in other words, portions of the digital twin may be ignored or removed (from the instantiated digital twin) and the simulation may still be performed with little-to-no impact on the outcome. In some such embodiments, step 915 may include removing nodes from the compute sequence that are irrelevant or otherwise may be ignored.

In step 920, the simulator determines how many timesteps should be simulated. This determination may be made based on the parameters of the simulation request (e.g., the period of time or the point in time which is desired to be simulated) and the timestep granularity of the digital twin. For example, if the request indicates that the simulation should be over the 2-hour period starting 1 hour in the future and ending three hours in the future, and the digital twin is configured to simulate timesteps of one minute, the simulator may determine that it will simulate 180 timesteps−60 timesteps to get to the beginning of the period, then an additional 120 timesteps during which data will be collected to get to the end of the period.

The method 900 then begins iterative simulation by, in step 925, identifying the next node to be computed by, for example, reading the next node in line on the compute sequence established in step 915. In step 930, the simulator reads the qaunta objects (if any) at each input interface of the node. Such quanta objects may have been output and made available by other nodes on the preceding (or other previous) timestep simulation. In some embodiments, quanta may not be available at any node interfaces on the first iteration of a simulation, while in others the digital twin, upon instantiation for simulation, may already track representations of the current system state including quanta objects that may be used on the first iteration. In step 935, the simulator applies any activation functions to the quanta objects read at step 930. Such activation functions may modify the state of the node or the quanta objects (e.g., in either case, updating internal properties thereof). In step 940, the simulator finishes the current timestep simulation for the current node by outputting any quanta objects to the node's output interfaces for use by other nodes in later timesteps.

In step 945, the simulator determines whether it has reached the end of the compute sequence. If not, the method 900 loops back to step 925 to compute the next node in the compute sequence. Once the simulator has computed all nodes in the compute sequence, the method 900 proceeds from step 945 to step 950, where the simulator reads the relevant simulated values from the output node(s) identified in step 910, and then to step 955, where the simulator records the new values to one or more time-series value curves. In this manner, the simulator may gradually build one or more curves describing the change in the simulated values over a period of time.

In step 960, the simulator determines whether it has finished simulating the number of timesteps identified in step 920. If not, the simulator returns to the beginning of the compute sequence in step 965, and the method 900 loops back to step 925 to begin computing the nodes for the next timestep. Once the desired number of timesteps has been simulated, the simulator return the value curves built up over successive executions of step 955 to the requestor in step 970 and the method 900 proceeds to end in step 975.

It will be apparent that method 900 is but one example of a method for performing a simulation and that other approaches may be used. In some embodiments, the simulator may be able to simulate according to multiple approaches, and the desired approach may be specified in the initial request. In some embodiments, rather than time-series value curves, a requestor may only desire single point values representing the state of the system at the end of simulation; in such embodiments, steps 950, 955 may be replaced with an alternate step between steps 960 and 970, wherein the simulator simply reads the simulated values from the output nodes. In some embodiments, the simulation may not return any output values to the requestor and, instead, may be responsible only for simulating the digital twin to a particular point in time; in such embodiments, steps 950, 955 may be omitted and step 970 may be replaced with a step that merely indicates to the requestor that the simulation is finished and the simulated digital twin is ready for introspection or any other process desired by the requestor. Various additional modifications will be apparent.

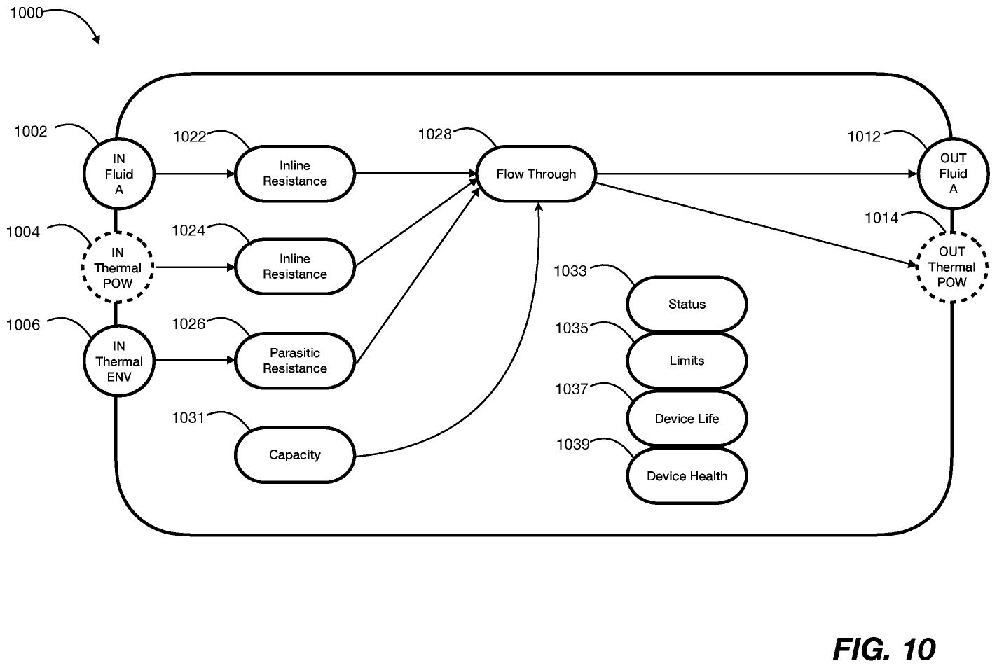

As previously explained, the elementary component of a composable digital twin may be referred to as a component. More sophisticated models are formed by connecting these component digital twins together to form complex and emergent behaviors. Drilling down into a component digital twin reveals the inner workings of the component as a set of normalized interfaces, behaviors, and properties. FIG. 10 illustrates an example component digital twin 1000 arrangement. This component digital twin 1000 may correspond to a digital twin 220, as previously described, and more specifically, to the transformer node 510. As will be understood, this more detailed view may show additional features omitted from the description of the transformer node 510, such as additional interfaces and alternative arrangement of activation functions.

The component digital twin 1000 includes three normalized input interfaces 1002, 1004, 1006 and two normalized output interfaces 1012, 1014. A fluid input interface 1002 and a fluid output interface 1012 may operate similar the similarly-identified interfaces 512, 514—the fluid input interface 1002 may receive fluid quanta objects from other component digital twins, while the fluid output interface 1012 may send fluid quanta objects to other component digital twins. Likewise, the thermal output interface 1014 may correspond or operate similar to the similarly-identified thermal output interface 516—it may output thermal quanta objects to other component digital twins.

A thermal input interface 1004 may also be included in the component digital twin 1000 and perform somewhat as expected—it may receive thermal quanta objects from other component digital twins. The inclusion of both a thermal input interface 1004 and a thermal output interface 1014 may follow from an understanding of the role of a transformer and the physics at play. The amount of heat transfer from one medium to another is a function of the relative heats of the two media. It is not enough to know that the first medium is 100° if one wishes to simulate the effect it will have on the second medium. The second medium temperature (or thermal energy) should be known. If the second medium is 20°, the first medium will behave exothermically to transfer thermal energy to the second medium. If, on the other hand, the second medium is 200°, the first medium will behave endothermically to pull thermal energy from the second medium. As such, in some embodiments, the thermal input interface 1004 and thermal output interface 1014 may be intended for connection to the same other component, so that the transformer component twin 1000 can take into account the other medium's temperature (as learned via the thermal input interface 1004) when deciding how much thermal quanta will be transferred out (if any) to that other medium (via the thermal input interface 1010). In some embodiments, to enforce the connection of both normalized interfaces 1004, 1014, they may be combined into a single multi-directional interface for purposes of composability. This combination may be achieved merely graphically, such that two interfaces are represented as a single interface to which the user may connect another matching digital twin normalized interface, or in the data arrangement itself, where the interface is in fact modeled as a single interface that will both input and output matching quanta (and may thus be viewed as two separate “virtual” normalized interfaces shown in dotted lines in FIG. 10).

Finally, a third thermal input interface 1006 may receive thermal quanta that describes the ambient temperature around the device or system aspect modeled by the component digital twin 1000. Such information may also be useful in modeling the physics of a heat transfer, as the environment itself may transfer or pull thermal energy from the system being modeled.

Moving on from interfaces, the component digital twin 1000 includes a collection of behaviors 1022, 1024, 1026, 1028, which implement functions that define how the component digital twin 1000 operates. These behaviors 1022, 1024, 1026, 1028 may, for example, operate on the quanta propagating through the component digital twin 1000 or the internal properties 1031, 1033, 1035, 1037, 1038 of the component digital twin 1000. As such, the behaviors 1022-1028 may correspond to the previously-described activation functions of a digital twin node and, more particularly, to the activation functions 513, 515, 517 of the transformer node 510.

Two inline resistance behaviors 1022, 1024 may model the natural resistance the component digital twin 1000 imparts on the flow of quanta through the modeled device or system aspect. For example, in the context of fluid quanta, the inline resistance behavior 1022 may model the natural tendency of the transfer coil to drop the fluid pressure from one end to the other. In the context of thermal quanta, the inline resistance behavior 1024 may model the insulation/heat conductivity of the transfer coil to heat energy transferring through the coil material to the fluid. A parasitic resistance behavior 1026, then, may model the tendency of thermal energy to be received from or lost to the surrounding environment, depending on the relative temperatures thereof. These three behaviors 1022, 1024, 1026 may modify the properties of the quanta object being received from their respective interfaces 1002, 1004, 1006, and then pass the three quanta objects to another behavior 1028 for further processing.

The flow-through behavior 1028 may model how much of each quanta passes through the component digital twin 1000 in a timestep via the output interfaces 1012, 1014. As such, the flow-through behavior 1028 may be seen as a primary behavior for the component digital twin 1000, driving the most basic operation thereof- to pass quanta through the digital twin. As shown, the flow-through behavior 1028 may receive fluid quanta from the inline resistance behavior 1022 and, based on the pressure property of that fluid quanta and the internal capacity property 1031 of the component digital twin 1000, determine how much of the fluid quanta will be output to the fluid output interface 1012. The flow-through behavior 1028 may also determine how much to adjust the temperature of the fluid quanta before it is output to the fluid output interface 1012 as it flows through based on the thermal quanta provided by the inline resistance 1024 and parasitic resistance 1026 behaviors. Similarly, the flow-through function may determine what thermal quanta to output (if any) via the thermal output interface 1014 based on how much the temperature of the fluid quanta was adjusted.

The component digital twin 1000 also includes a collection of internal properties, including capacity 1031, status 1033, limits 1035, device life 1037, and device health 1039. These properties may be used by the behaviors 1022-1028 in determining their operation on each timestep or may be modified by the behaviors 1022-1028. For example, the flow-through 1028 may modify its own operation based on the capacity 1031 and limits 1035 properties, and may adjust the status 1033, device life 1037, and device health 1039 properties as part of its own operation.

The component digital twin 1000 may be but one example of a component digital twin, and various alternative collections of interfaces, behaviors, and properties may be used for different component digital twins. Such alternative collections may be a matter of design choice or may be determined by the actor or quanta type for the component digital twin. For example a component digital twin for a fluid store may include a mixing function instead of a flow through function for modeling the behavior of adding new fluid to already stored fluid, and a property tracking a current fill level. Various alternative embodiments will be apparent.

In addition to use for simulation, the component digital twin 1000 may be useful for tracking otherwise hidden properties of real world devices or system aspects. For example, by keeping the operation of the digital twin tracking the observed operation of its real-world counterpart, the behaviors 1022-1028 may modify internal properties, such as device life 1037 to keep track of the remaining life of the device and device health 1039 to report a current fault or other health status.

In some embodiments, one or more of the properties may represent controls of the device. For example, control of a device to be activated or not, or control of a flow rate through a device. Such properties may thus modify the operation of the behaviors of the component digital twin 1000. In such embodiments, these properties may thus be tunable for the purposes of simulation or control path finding, to locate a desired system operation before real world devices are actually controlled.

In various embodiments, the component digital twins 1000 may be composable in a manner similar to that described with regard to the composability of the nodes. For example, a user may utilize a library of behaviors, properties, and normalized interfaces to construct new component digital twins to represent new devices or other system aspects. Such an interface for composing component digital twins may be text based, graphical based, or a combination thereof.

As noted above, various concepts associated with composing higher order digital twins may be used or adapted for composing component digital twins, including the use of graphical interfaces to facilitate such composition. FIG. 11 illustrates a first example interface 1100 for composing a component digital twin. This interface 1100 may be provided, for example, to a user by the digital twin creator 218 or the digital twin composition instructions 874, and may be provided on the interface of a controller 210, on another device such as a personal computer or mobile device, by a server or other host device via a web interface, or any other means. In some embodiments, the first interface 1100 for component digital twin composition may be part of the same suite of software that provides the interface 400 for system digital twin composition, or these interfaces 400, 1100 may be part of separate and independent software tools.

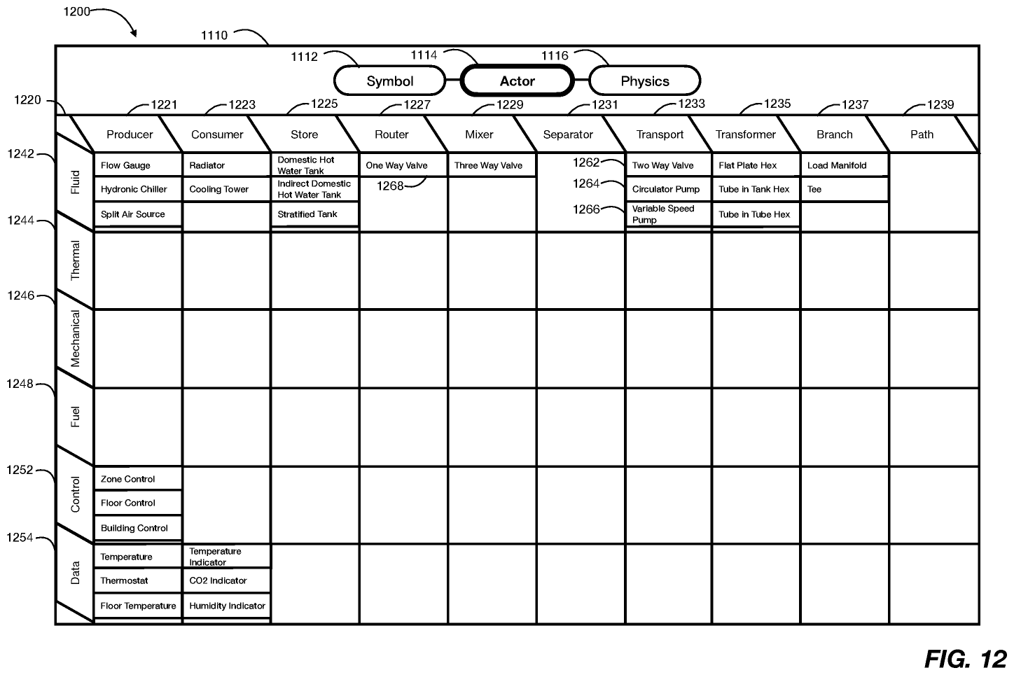

As illustrated, the interface 1100 may share some similar features to interface 400. For example, a navigation panel 1110 may include a set of ordered indicators 1112, 1114, 1116 conveying an overall workflow for component digital twin composition: a Symbol indicator 1112 associated with defining an avatar for the new component digital twin, an Actor indicator 1114 associated with specifying an actor and quanta type for the new component digital twin, and a Physics indicator 1116 associated with specifying the properties and behaviors for the new component digital twin. The Symbol indicator 1112 has an altered appearance compared to the other indicators 1114, 1116 (here, bold text and thick outer lines, but any alteration can be used) to indicate that it is the presently active step and associated with the presently-displayed interface 1100. In some embodiments, visual or other cues can be used to indicate additional workflow information: that the steps associated with earlier indicators have been completed, that the current step is ready or not ready to be completed, that there is a problem with a step associated with an indicator 1112, 1114, 1116, etc. In some embodiments, the indicators 1112-1116 may be interface buttons that enable, upon user click, tap, or other selection, the user to change the interface 1100 to another interface associated with the selected indicator 1112-1116 (such as the interfaces that will be described in connection with FIGS. 12-14).

A workspace 1120 includes an area where a user may graphically construct the avatar for the component digital twin. As explained above, the avatar may be a graphical depiction of an “under the hood” digital twin and the avatar may be used in the interface 1100 or other interfaces (such as interface 400) to compose higher order digital twins by connecting avatars together. A tool panel 1130 may include a number of buttons 1131, 1132, 1134, 1136, 1138 that, when selected, provide respective tools for the user to interact with the workspace 1120 or the avatar elements 1121, 1122, 1124, 1126, 1128 therein. For example, a cursor button 1132 provides the user with a simple cursor for clicking and dragging the avatar elements 1121-1128 relative to the workspace 1120 and each other; a drawing tools button 1134 provides the user with various additional drawing tools such as the ability to draw shapes (e.g., a square or other shape to represent the main body of an avatar, such as avatar element 1121) and to draw connections indicating a functional connection between certain avatars 1121-1128 (as will be explained in greater detail below); a text button 1136 provides the user with the ability to annotate; and a pan button 1138 allows the user to drag the view provided by the workspace 1120 of the avatar elements 1121-1128 in any direction. Various additional tools may be provided without the use of buttons such as a zoom tool usable with a mouse scroll wheel or a pinch gesture. Various additional tools for interacting with a graphical design environment will be apparent.

The user interface 1100 may thus allow the user to draw a graphical representation that will serve as the avatar for the new component digital twin once finished and that may be used to graphically compose new, more complex digital twins (e.g., using interface 400). Selection of the drawing tools button 1134 may cause the interface 1100 to display a popup (not shown) with additional tools for selection such as a line drawing tool, a rectangle/square drawing tool, a polygon drawing tool, etc. The interface 1100 may also provide tools (not shown) for specifying specifics of the items to be drawn, such as line thickness, line color, fill color. As shown, the user has used the drawing tools to draw a single square 1121 to represent the component digital twin. It will be apparent that the told may enable the user to draw more complex sets of shapes to serve as an avatar. Additionally, a library pane 1140 may provide the user with access to a library of pre-drawn avatar images 1142, 1144, 1146, 1148 that may be inserted into the workspace 1120 for use as an avatar or portion thereof. In some embodiments, the pre-drawn avatar images 1142, 1144, 1146, 1148 may be previously constructed using the same drawing tools previously described and, as such, may be further modified by the user (e.g., to add or remove shapes, or change colors) using the tools available via the drawing tools button 1134.

A normalized interface button 1131 may provide a user with a tool for specifying the normalized interfaces 1122, 1124, 1126, 1128 that will be included in the component digital twin under construction. Upon the user selecting the normalized interface button 1131, the interface 1100 displays a popup 1139 for selecting the desired normalized interface to be added to the workspace 1220. The popup 1139 provides a set of selectable normalized interface icons—input, output, and input-output normalized interfaces for each of the quanta types known to the system. The direction of the normalized interface may be indicated by the icon shape, while the quanta type may be indicated by an icon color. Upon placement of a normalized interface 1122-1128, the interface 1100 may allow the user to reposition it relative to the other avatar elements 1121-1128, resize it, rotate or reorient it, flip it, or otherwise transform the graphical representation of the normalized interface. As shown, the user has used the popup 1139 to add and position a fluid in normalized interface 1122, a fluid out normalized interface 1124, a mechanical in normalized interface 1126, and a mechanical out normalized interface 1128 adjacent the square 1121.

In various embodiments, the normalized interfaces 1122-1128 may or may not form a portion of the graphical avatar that will be displayed on other interfaces for composing digital twins, or the normalized interfaces 1122-1128 may be shown in a different manner in such other interfaces (e.g., as a simple dot or hanging line indicating a connection point, as with the connection points 427, 428). In some embodiments, the normalized interfaces 1122-1128 may indicate not only (or no) literal graphical information for use as an avatar and may include functional information. For example, the normalized interfaces 1122-1128 may include functional information for enabling graphical composition such as identifying the points and directions where connectors will be able to connect in such other interfaces. As another example, the normalized interfaces 1122-1128 may include functional information for defining the digital twin that the avatar will represent. As noted, the normalized interfaces 1122-1128 indicate both a direction of the interface (input or output) and a quanta type. As will be understood in view of the foregoing description, this information may be used by the digital twin itself for representing, simulating, or otherwise modeling a real world device. As such, this information may be carried forward to the later steps of component digital twin creation.

The interface 1100 may also include a properties panel 1150 to enable the user to browse or set certain properties that will be associated with the avatar or the new component digital twin. For example, as shown, a text box 1152 may allow the user to enter a name for the new component digital twin. In this example, the user has entered a name of “One Way Valve Body” that will be used going forward. Various additional properties for the properties panel 1150 will be apparent.

Once the user is satisfied with the avatar created using the first interface 1100, the user may proceed to the next step of component digital twin creation by, for example, clicking on the actor indicator 1114. FIG. 12 illustrates an illustrates a second example interface 1200 for composing a component digital twin. The second example interface 1200 may be displayed to guide the user in such next step: selecting an actor and internal quanta type.

The second interface includes a grid 1220 for enabling a user to select a combination of actor and internal quanta type. On a first axis, a list of possible actors is included. As shown, the interface 1220 has made available 10 different actor columns for the user to choose from: a producer actor column 1221 (whose role is to produce quanta), a consumer actor column 1223 (whose role is to consume quanta), a store actor column 1225 (whose role is to store quanta), a router actor column 1227 (whose role is to direct quanta among one or more possible paths), a mixer actor column 1229 (whose role is to mix multiple quanta together), a separator actor column 1231 (whose role is to separate quanta into multiple separate quantities), a transport actor column 1233 (whose role is to cause quanta to move), a transformer actor column 1235 (whose role is to transform one type of quanta into another type of quanta), a branch actor column 1237 (whose role is to allow quanta to move along multiple paths), and a path actor column 1239 (whose role is to allow quanta to move along a single path).

On a second axis, a list of possible internal quanta is included. As shown, the interface 1220 has made available 6 different quanta rows for the use to choose from: a fluid quanta row 1242 (e.g., representing fluid such as water or gas), a thermal quanta row 1244 (e.g., representing thermal energy), a mechanical quanta row 1246 (e.g., representing mechanical energy), a fuel quanta row 1248 (e.g., representing electricity or other “fuel” for powering other devices or aspects of a system), a control quanta row 1252 (e.g., representing signals, commands, or other control events for devices or aspects of a system), and a data quanta row 1254 (e.g., representing network packets, sensor data, or other data that may be transported through a system). It will be apparent that, in other embodiments, different sets of actors or quanta types may be recognized and made available by the interface 1200.

Various approaches may be used to select a combination of actor and quanta type. In some embodiments, the user may simply select the square of the grid 1220 at the desired intersection of actor quanta column 1221-1239 and quanta type row 1242-1254 and move on to the next step and the next interface with a generic digital twin for that actor and quanta combination. In some embodiments, specialized selections (e.g., as may have been previously constructed by a user or system administrator) may be made available in such squares of the grid. As shown, the interface 1200 includes three different options 1262, 1264, 1266 at the intersection of the transport actor row 1233 and the fluid quanta type row 1242. These options include a two-way valve option 1262, a circulator pump 1264, and a variable speed pump 1266. In such an embodiment, selection of one of these options 1262, 1264, 1266 by the user may not only identify the actor and quanta type for the new component digital twin, but also a set of default behaviors or properties from which to begin on the following step. In some embodiments, the interface 1200 may provide all such available options 1262, 1264, 1266, 1268 while, in other embodiments, the interface 1200 may pre-filter the options 1262, 1264, 1266 based on, e.g., the normalized interfaces selected by the user on the previous interface 1100. That is, if an option 1262, 1264, 1266 does not match at least some of the selected normalized interfaces, it may be omitted from the interface 1200. In some such embodiments, in no options for a particular actor or quanta type are available, the entire column or row, respectively, may be omitted.

As noted, selection of an actor and quanta type using the interface 1200 may establish the digital twin template (e.g., starting behaviors or properties) from which the user will begin in the next step. Alternatively or additionally, such selection may attach ontological labels to the new component digital twin, specifying its role or “reason for being.” With this information, meaning can be ascribed to the component digital twin and higher level reasoning may be applied to a larger digital twin composed from such ontologically-labeled component digital twins. For example, when such a reasoning process can understand the roles of each component digital twin (due to ontological labeling as, e.g., a particular actor with a particular quanta type), it may extract further insights about the operation of a larger system.

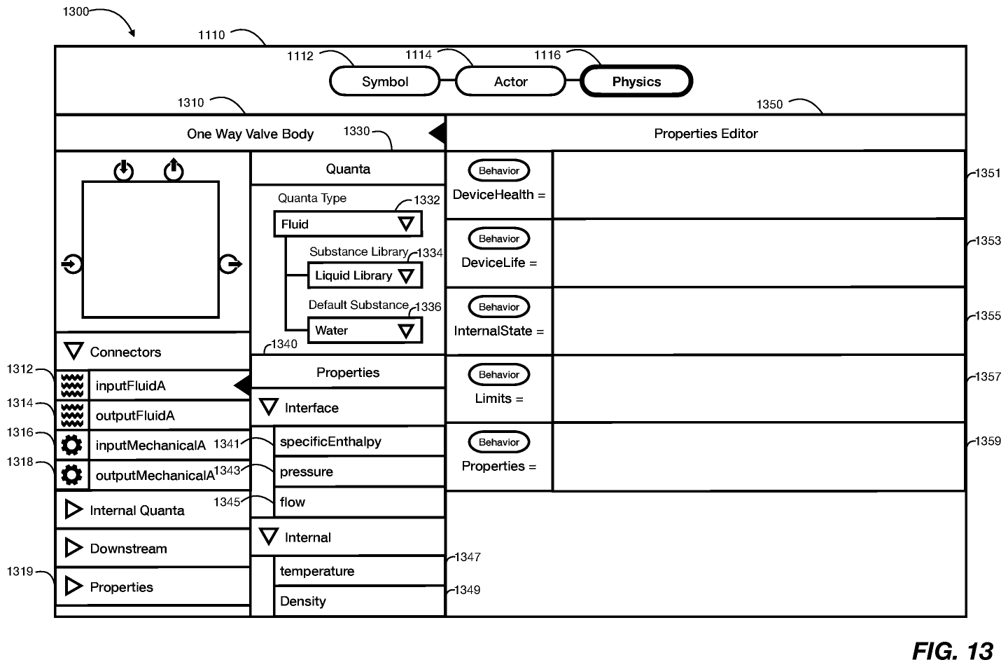

To continue with the workflow, the user may select the one way valve option 1268, indicating that the new component digital twin will be labeled as a router actor with an internal fluid quanta type. FIG. 13 illustrates a third example interface 1300 for composing a component digital twin. This third interface 1300 may be displayed in response to a user selection from the grid 1220 of the previous interface 1200.

The interface 1300 includes a explorer panel 1310 that enables the user to select different aspects of the component digital twin for investigation or modification. The explorer panel 1310 includes selectable entries for providing a detailed view of the four normalized interfaces 1122-1128 added using the first interface 1100: a fluid in interface entry 1312, a fluid out interface entry 1314, a mechanical in interface entry 1316, and a mechanical out interface entry 1318. Upon selection of one of these interface entries 1312-1318, a detail sub-panel 1330 of the explorer panel 1310 may update to show detailed information about the corresponding normalized interface and allow the user to make changes thereto. Presently, the fluid in interface entry 1312 is selected, and the detail sub-panel shows details about the corresponding fluid in interface's configuration. In particular, a group of drop-down selectors 1332, 1334, 1336 indicate that the interface is configured to receive fluid quanta type and that the specific quanta may be water (belonging to the liquid library of fluid quanta) or may exhibit properties the same as, or sufficiently close, to water. The selector 1332 may enable the user to change the quanta type of the selected normalized interface (e.g., to mechanical or thermal). The selector 1334 may enable the user to change the grouping of quanta substances to be used (e.g., to a gas library, gas-to-liquid phase change library, or liquid-to-gas phase change library). The selector may enable the user to change the substance properties for the quanta (e.g., to glycol, alcohol, or a water/glycol mixture). Selection of these options may provide values for various properties or behaviors of the quanta receivable via the selected interface. For example, selection of water may set the density property of the quanta with one value, while selection of glycol may set the density property of the quanta with a different value. As such, the user may be able to, with a few selections, import the physical behaviors and properties that will be used by the component digital twin for simulation and other purposes.

In some embodiments, one or more properties or behaviors of the selected interface entry 1312 may be manually-defined or modified by the user. A properties section 1340 of the detail sub-panel 1330 lists multiple property entries 1341, 1343, 1345, 1347, 1349 associated with the interface. Upon selection of a property entry 1341, 1343, 1345, 1347, 1349, an editor panel 1350 may be updated to provide interface elements for the user to define new values or formulae for computing values for those properties of the selected interface entry 1312. At present, no such property entry 1341, 1343, 1345, 1347, 1349 is selected, and the editor panel 1350 instead provides a listing of multiple behaviors and properties 1351, 1353, 1355, 1357, 1359 associated with the component digital twin component as a whole, rather than behaviors and properties associated with the selected normalized interface entry 1312 or the quanta associated therewith.

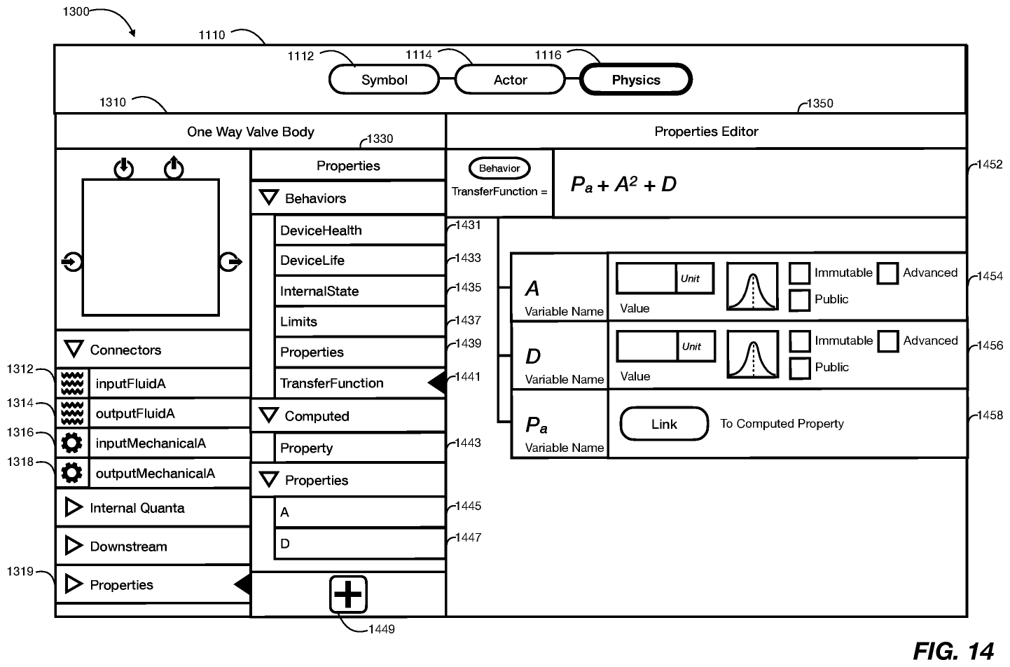

Various other aspects of the new component digital twin may be explored or modified via the interface 1300 as well through selection of other entries of the explorer panel 1310, such as a properties entry 1319. FIG. 14 illustrates a fourth example interface 1400 for composing a component digital twin. This interface 1400 may be displayed in response to selection of the properties entry 1319 of the previous interface 1300.

Here, the detail sub-panel 1330 includes a list of behavior entries 1431, 1433, 1435, 1437, 1439, 1441; a list of computed property entries 1443; and a list of other property entries 1445, 1447. A new entry button 1449 may enable the user to add to these lists by defining new behaviors and properties to be included in the new component digital twin. Upon selection of one of these entries 1431-1447, the editor panel 1350 may be updated to show editing tools for defining or modifying the associated behavior or property. In the displayed interface 1400, the TransferFunction behavior 1441 has been selected, and the editor panel 1350 presents an interface element 1452 for defining the TransferFunction behavior. Here, the user has entered the function “Pₐ+A²+D” as the mathematical definition of this behavior. These three symbols, in turn, may be linked to other behaviors and properties known to the new component digital twin. In this manner, a flow of quanta and computation through the new component digital twin may be defined. The editor panel 1350 may provide additional interface elements 1454, 1456, 1458 for specifying various parameters of these variables Pₐ, A, and D. With definition of such a function and linking the function to one of the interfaces, this function may be applied as one of the activation functions of the component digital twin during operation.

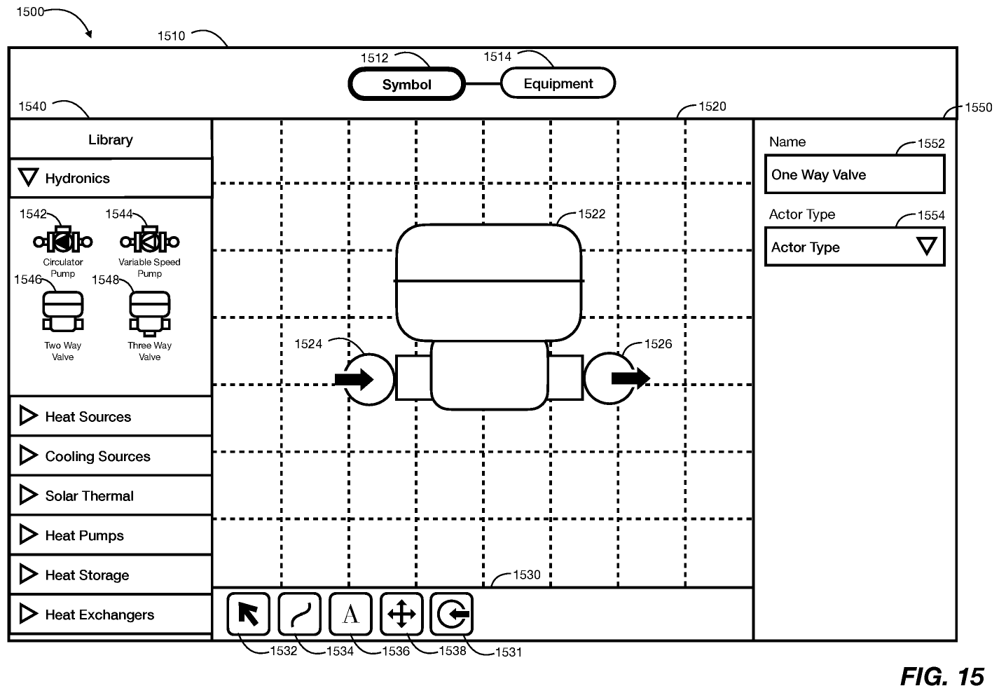

As disclosed, interfaces may be provided for defining system level digital twins as well as component level digital twins. It will be understood that such interfaces may be capable of defining digital twins at different levels of detail or additional interfaces may be provided for defining other level digital twins. For example, a dedicated interface may be provided for defining an equipment-level digital twin. FIG. 15 illustrates a first example interface 1500 for composing an equipment digital twin. This interface 1500 may be provided, for example, to a user by the digital twin creator 218 or the digital twin composition instructions 874, and may be provided on the interface of a controller 210, on another device such as a personal computer or mobile device, by a server or other host device via a web interface, or any other means. In some embodiments, the first interface 1500 for equipment digital twin composition may be part of the same suite of software that provides the interface 400 for system digital twin composition, the interface 1100 for component digital twin composition, or these interfaces 400, 1100, 1500 may be part of separate and independent software tools.

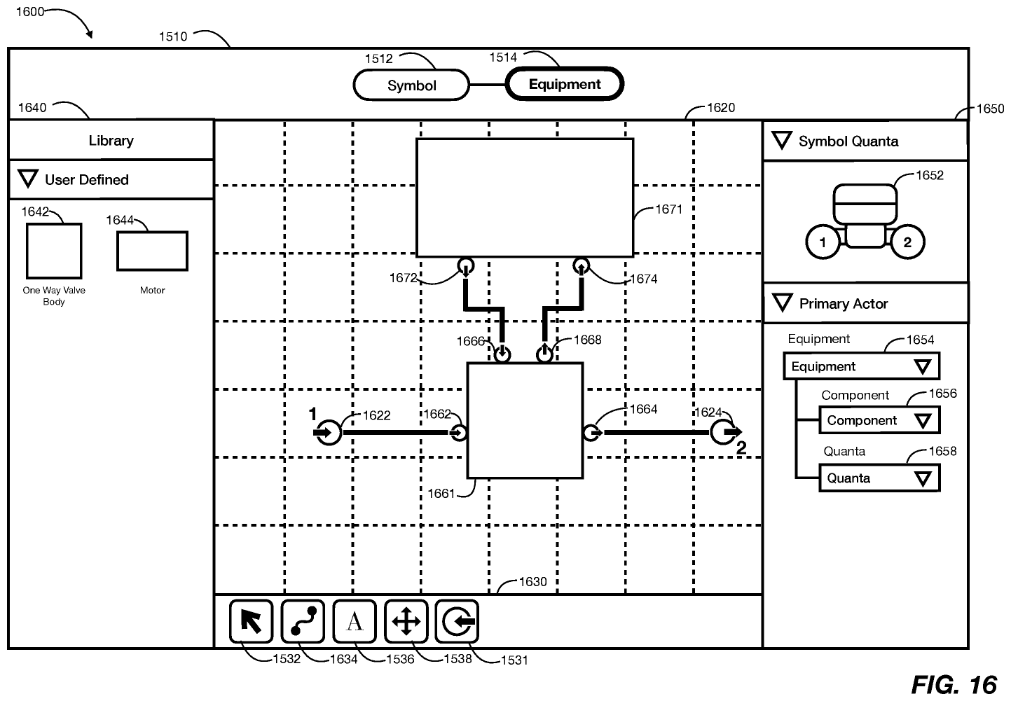

As illustrated, the interface 1500 may share some similar features to interfaces 400 and interface 1500. For example, a navigation panel 1510 may include a set of ordered indicators 1512, 1514 conveying an overall workflow for equipment digital twin composition: a Symbol indicator 1512 associated with defining an avatar for the new equipment digital twin, and an Equipment indicator 1514 associated with composing the equipment digital twin from other digital twins. The Symbol indicator 1512 has an altered appearance compared to the other indicator 1514 (here, bold text and thick outer lines, but any alteration can be used) to indicate that it is the presently active step and associated with the presently-displayed interface 1500. In some embodiments, visual or other cues can be used to indicate additional workflow information: that the steps associated with earlier indicators have been completed, that the current step is ready or not ready to be completed, that there is a problem with a step associated with an indicator 1512, 1514, etc. In some embodiments, the indicators 1512, 1514 may be interface buttons that enable, upon user click, tap, or other selection, the user to change the interface 1500 to another interface associated with the selected indicator 1512, 1514 (such as the interface that will be described in connection with FIG. 16).

A workspace 1520 includes an area where a user may graphically construct the avatar for the equipment digital twin. As explained above, the avatar may be a graphical depiction of an “under the hood” digital twin and the avatar may be used in the interface 1500 or other interfaces (such as interface 400) to compose higher order digital twins by connecting avatars together. A tool panel 1530 may include a number of buttons 1531, 1532, 1534, 1536, 1538 that, when selected, provide respective tools for the user to interact with the workspace 1520 or the avatar elements 1522, 1524, 1526 therein. For example, a cursor button 1532 provides the user with a simple cursor for clicking and dragging the avatar elements 1522-1526 relative to the workspace 1520 and each other; a drawing tools button 1534 provides the user with various additional drawing tools such as the ability to draw shapes (e.g., a square or other shape to represent the main body of an avatar, such as avatar element 1522) and to draw connections indicating a functional connection between certain avatars 1524, 1526 (as will be explained in greater detail below); a text button 1536 provides the user with the ability to annotate; and a pan button 1538 allows the user to drag the view provided by the workspace 1120 of the avatar elements 1522-1526 in any direction. Various additional tools may be provided without the use of buttons such as a zoom tool usable with a mouse scroll wheel or a pinch gesture. Various additional tools for interacting with a graphical design environment will be apparent.

The user interface 1500 may thus allow the user to draw a graphical representation that will serve as the avatar for the new component digital twin once finished and that may be used to graphically compose new, more complex digital twins (e.g., using interface 400). Selection of the drawing tools button 1534 may cause the interface 1100 to display a popup (not shown) with additional tools for selection such as a line drawing tool, a rectangle/square drawing tool, a polygon drawing tool, etc. The interface 1500 may also provide tools (not shown) for specifying specifics of the items to be drawn, such as line thickness, line color, fill color. Additionally, a library pane 1540 may provide the user with access to a library of pre-drawn avatar images 1542, 1544, 1546, 1158 that may be inserted into the workspace 1520 for use as an avatar or portion thereof. In some embodiments, the pre-drawn avatar images 1542, 1544, 1546, 1548 may be previously constructed using the same drawing tools previously described and, as such, may be further modified by the user (e.g., to add or remove shapes, or change colors) using the tools available via the drawing tools button 1534. As shown, the user has dragged the two-way valve avatar 1546 to the workspace to use as the avatar element 1522 and may have changed a color of one or more of the graphical elements thereof.

A normalized interface button 1531 may provide a user with a tool for specifying the normalized interfaces 1524, 1526 that will be included in the equipment digital twin under construction. Upon the user selecting the normalized interface button 1531, the interface 1500 displays a popup (not shown) for selecting the desired normalized interface to be added to the workspace 1520. The popup may be similar to the similar popup 1139 described in connection with interface 1100. Upon placement of a normalized interface 1524, 1526, the interface 1500 may allow the user to reposition it relative to the other avatar elements 1522, resize it, rotate or reorient it, flip it, or otherwise transform the graphical representation of the normalized interface. As shown, the user has used the normalized interface button 1531 to add and position a fluid in normalized interface 1524, and a fluid out normalized interface 1526. As previously-described in connection with interface 1100, the normalized interfaces 1524, 1526 may form a portion of the visualized avatar, define rendering functional information, or define functional information used in the underlying digital twin itself.

The interface 1500 may also include a properties panel 1550 to enable the user to browse or set certain properties that will be associated with the avatar or the new equipment digital twin. For example, as shown, a text box 1552 may allow the user to enter a name for the new component digital twin. In this example, the user has entered a name of “One Way Valve” that will be used going forward. A drop-down selector 1554 may also allow the user to identify the actor ontological labeling to apply to the new equipment digital twin. In some embodiments, such ontological labeling may instead be inferred from the digital twins and arrangement thereof that will be specified by the user (e.g., using the interface described in connection with FIG. 16) as defining the equipment digital twin. Various additional properties for the properties panel 1550 will be apparent.

Once the user is satisfied with the avatar created using the first interface 1500, the user may proceed to the next step of equipment digital twin creation by, for example, clicking on the equipment indicator 1514. FIG. 16 illustrates a second example interface 1600 for composing an equipment digital twin. This interface 1600 may be displayed after the interface 1500 to enable the user to finish creating a new equipment digital twin.

This interface 1600 presents a workspace 1620 for composing the equipment digital twin by connecting one or more other digital twins (such as component digital twins). As such, a library panel 1640 provides access to already-defined digital twins 1642, 1644 (represented by their corresponding avatars) for the user to add to the workspace 1620. The tool panel 1630 now includes a connector tool 1634 in place of the drawing tool 1534 to enable the user to define functional connections between digital twins, over which quanta objects will propagate during operation. The properties panel may illustrate a view of the equipment digital twin avatar 1652 along with a numbering of its normalized interfaces (as may have been placed by the user on the previous interface 1500). Additional drop-down selectors 1654, 1656, 1658 may also be provided to allow the user to specify additional properties of the equipment digital twin such as the digital twin from which the actor and quanta ontological labeling will be inherited.

As shown, the user has already composed a digital twin. The composition process may have begun with initial normalized interfaces 1622, 1624, being placed automatically at the beginning of design to correspond to the normalized interfaces 1524, 1526 placed by the user on the previous interface 1500. Next, the user may have dragged the one way valve body avatar 1642 from the library panel to create the avatar 1661 representing that component digital twin. This one way valve body avatar 1661 may correspond to the component digital twin created by the user in connection with interfaces 1100, 1200, 1300, 1400. As such, the one way valve body avatar 1661 includes a fluid in interface 1662, a fluid out interface 1664, mechanical in interface 1666, and mechanical out interface 1668. The user then used the connector button 1624 to connect the equipment fluid in normalized interface 1622 to the one way valve body fluid in interface 1662; and to connect the equipment fluid out normalized interface 1624 to the one way valve body fluid in interface 1664. As such, the user has specified that, when the digital twin receives fluid quanta, it is actually received by the component fluid in interface 1662 of the one way valve body component digital twin and, likewise, when the component fluid out interface 1664 outputs fluid quanta, it is presented from the equipment fluid out interface 1624.

Next, the user has dragged the motor digital twin avatar 1644 to the workspace 1620 to create an instance of the motor digital twin avatar 1671 and thereby indicate that the corresponding motor digital twin will be included as part of the equipment digital twin being defined. This motor digital twin may be a component digital twin (e.g., as may have previously been defined via interfaces 1100, 1200, 1300, 1400), another equipment digital twin (e.g., as may have been previously defined via interfaces 1500, 1600), or any other level digital twin. The motor digital twin avatar may include a mechanical out normalized interface 1672 (which the user has connected to the mechanical in normalized interface 1666 of the one way valve body avatar 1661) and a mechanical in normalized interface 1674 (which the user has connected to the mechanical out normalized interface 1668 of the one way valve body avatar 1661). Thus, the one way value digital twin, as defined by the user, will involve passing mechanical quanta internally (which may be useful for monitoring the specific operation of a real world device, such as tracking the lifetime of mechanical components thereof), from the equipment level, the digital twin may be viewed as simply receiving and outputting fluid quanta. The user may then complete the definition of the new equipment digital twin which may then be made available for definition of further digital twins (e.g., via library panel 440 or library panel 1640).

It should be apparent from the foregoing description that various example embodiments of the invention may be implemented in hardware or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a mobile device, a tablet, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain example aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the scope of the claims.

We claim:

1. A method performed by a processor for performing a simulation of a system, the method comprising:
accessing a digital twin stored in memory, wherein the digital twin comprises:
a plurality of nodes, each node having at least one normalized interface associated with data having a respective data type, and
a plurality of edges connecting respective normalized interfaces associated with like data types among the plurality of nodes;
propagating data having a first data type through the plurality of nodes along edges of the plurality of edges connected to normalized interfaces associated with the first data type; and
extracting data from at least one node of the plurality of nodes to be used as simulation output.

2. The method of claim 1, further comprising:
propagating data having a second data type through the plurality of nodes along edges of the plurality of edges connected to normalized interfaces associated with the second data type.

3. The method of claim 1, wherein:
each node of the plurality of nodes comprises an activation function, and
the step of propagating data comprises applying the activation function of a node to the data as the data is propagated through the node.

4. The method of claim 1, further comprising repeating the step of propagating data for a number timesteps, wherein the number of timesteps is selected based on the period of time for which simulation is to be performed.

5. The method of claim 1, further comprising:
identifying at least one node of the plurality of nodes that will provide simulation output, and
the step of propagating data comprises propagating data from other nodes of the plurality of nodes toward the at least one node that will provide simulation output.

6. The method of claim 1, wherein each node of the plurality of nodes is associated with a property, the method further comprising:
updating the property of at least one node of the plurality of nodes based on propagating the data,
wherein extracting data from the at least one node comprises reading the property of the at least one node.

7. The method of claim 1, wherein:
each node of the plurality of nodes is labeled according to an ontology to represent an actor within the system, and
each data type is labeled according to the ontology to represent a quanta acted on by the system.

8. An apparatus for performing a simulation of a system, the apparatus comprising:
a memory storing a definition of a digital twin, wherein the digital twin comprises:
a plurality of nodes, each node having at least one normalized interface associated with data having a respective data type, and
a plurality of edges connecting respective normalized interfaces associated with like data types among the plurality of nodes; and
a processor in communication with the memory, the processor being configured to perform a simulation of a system, comprising:
propagating data having a first data type through the plurality of nodes along edges of the plurality of edges connected to normalized interfaces associated with the first data type.

9. The apparatus of claim 8, wherein, in performing the simulation, the processor is further configured to:
propagate data having a second data type through the plurality of nodes along edges of the plurality of edges connected to normalized interfaces associated with the second data type.

10. The apparatus of claim 8, wherein:
each node of the plurality of nodes comprises an activation function, and
in propagating data, the processor is configured to apply the activation function of a node to the data as the data is propagated through the node.

11. The apparatus of claim 8, wherein, in performing the simulation, the processor is configured to repeat the step of propagating data for a number timesteps, wherein the number of timesteps is selected based on the period of time for which simulation is to be performed.

12. The apparatus of claim 8, wherein:
in performing the simulation, the processor is configured to identify at least one node of the plurality of nodes that will provide simulation output, and
in propagating data, the processor is configured to propagate data from other nodes of the plurality of nodes toward the at least one node that will provide simulation output.

13. The apparatus of claim 8, wherein:
each node of the plurality of nodes is associated with a property;
in performing the simulation, the processor is configured to:
update the property of at least one node of the plurality of nodes based on propagating the data, and
read a value of the property of the at least one node;
utilize at least the value as output of the simulation.

14. The apparatus of claim 8, wherein:
each node of the plurality of nodes is labeled according to an ontology to represent an actor within the system, and
each data type is labeled according to the ontology to represent a quanta acted on by the system.

15. A machine-readable non-transitory medium encoded with instructions for execution by a processor, the machine-readable non-transitory medium comprising:
instructions for accessing a digital twin, wherein the digital twin comprises:
a plurality of nodes, each node having at least one normalized interface associated with data having a respective data type, and
a plurality of edges connecting respective normalized interfaces associated with like data types among the plurality of nodes;
instructions for propagating data having a first data type through the plurality of nodes along edges of the plurality of edges connected to normalized interfaces associated with the first data type; and
instructions for extracting data from at least one node of the plurality of nodes to be used as simulation output.

16. The machine-readable non-transitory medium of claim 15, further comprising:
instructions for propagating data having a second data type through the plurality of nodes along edges of the plurality of edges connected to normalized interfaces associated with the second data type.

17. The machine-readable non-transitory medium of claim 15, wherein:
each node of the plurality of nodes comprises an activation function, and
the instructions for propagating data comprise instructions for applying the activation function of a node to the data as the data is propagated through the node.

18. The machine-readable non-transitory medium of claim 15, further comprising instructions for repeating the instructions for propagating data for a number timesteps, wherein the number of timesteps is selected based on the period of time for which simulation is to be performed.

19. The machine-readable non-transitory medium of claim 15, further comprising:
instructions for identifying at least one node of the plurality of nodes that will provide simulation output, and
the instructions for of propagating data comprise instructions for propagating data from other nodes of the plurality of nodes toward the at least one node that will provide simulation output.

20. The machine-readable non-transitory medium of claim 15, wherein each node of the plurality of nodes is associated with a property, the medium further comprising:
instructions for updating the property of at least one node of the plurality of nodes based on propagating the data,
wherein the instructions for extracting data from the at least one node comprise instructions for reading the property of the at least one node.
